(19) United States
(12) Patent Application Publication
(10) Pub. No.: US 2026/0099284 A1
(43) Pub. Date: Apr. 9, 2026

(54) NON-TRANSITORY COMPUTER-READABLE STORAGE MEDIUM STORING APPLICATION PROGRAM, INFORMATION PROCESSING APPARATUS, AND CONTROL METHOD OF INFORMATION PROCESSING APPARATUS

(71) Applicant: CANON KABUSHIKI KAISHA, Tokyo (JP)

(72) Inventor: YU MATSUMOTO, Kanagawa (JP)

(21) Appl. No.: 19/350,210

(22) Filed: Oct. 6, 2025

(30) Foreign Application Priority Data
Oct. 8, 2024 (JP) 2024-176740

(51) Int. Cl. G06F 3/12

(52) U.S. Cl. CPC G06F 3/1236; G06F 3/1203; G06F 3/1222; G06F 3/1226; G06F 3/1286; G06F 3/1287; G06F 3/1292

(57) ABSTRACT

A computer-readable storage medium storing an application program configured to cause a computer of an information processing apparatus to: accept a connection setting instruction for performing connection setting of a communication apparatus; and transmit, to the communication apparatus, a search instruction for causing the communication apparatus to execute search processing of searching for a network formed by a predetermined access point connected to the information processing apparatus at least at a timing of accepting the connection setting instruction, wherein, based on that the communication apparatus does not support a predetermined authentication method used in the network, it is controlled not to transmit the search instruction to the communication apparatus, and based on that the communication apparatus supports the predetermined authentication method, it is controlled to transmit the search instruction to the communication apparatus.

### BACKGROUND

### Field of the Technology

The present disclosure relates to a non-transitory computer-readable storage medium storing an application program, an information processing apparatus, and a control method of the information processing apparatus.

### Description of the Related Art

A technique for causing a communication apparatus such as a printer to connect to another apparatus by an information processing apparatus such as a smartphone has been known. Japanese Patent Laid-Open No. 2016-127545 describes that an information processing apparatus transmits information to a communication apparatus, thereby setting the communication apparatus in a connection mode for deciding the connection form between the information processing apparatus and the communication apparatus.

### SUMMARY

The present disclosure provides a technique that improves convenience when an information processing apparatus causes a communication apparatus to connect to another apparatus.

The present disclosure in one aspect provides a non-transitory computer-readable storage medium storing an application program configured to cause a computer of an information processing apparatus to function as: a first acceptance unit configured to accept a connection setting instruction for performing connection setting of a communication apparatus; and a first transmission unit configured to transmit, to the communication apparatus, a first search instruction for causing the communication apparatus to execute search processing of searching for a first network formed by a predetermined access point connected to the information processing apparatus at least at a timing of accepting the connection setting instruction, wherein, based on that the communication apparatus does not support a predetermined authentication method used in the first network, it is controlled not to transmit the first search instruction to the communication apparatus, and based on that the communication apparatus supports the predetermined authentication method, it is controlled to transmit the first search instruction to the communication apparatus.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view showing an example of the configuration of a communication system;

FIG. 2 is a block diagram for explaining an example of the hardware configurations;

FIG. 3 is a flowchart showing an example of the processing executed by a terminal apparatus;

FIG. 4 is a flowchart showing an example of the processing executed by the terminal apparatus;

FIG. 5 is a flowchart showing an example of the processing executed by the terminal apparatus;

FIG. 6 is a flowchart showing an example of the processing executed by a communication apparatus;

FIG. 7 is a flowchart showing an example of the processing executed by the communication apparatus;

FIG. 8 is a flowchart showing an example of the processing executed by the communication apparatus;

FIGS. 9A to 9C are views each showing an example of a screen displayed on a display unit of the terminal apparatus;

FIG. 10 is a flowchart showing an example of the processing executed by a terminal apparatus;

FIG. 11 is a flowchart showing an example of the processing executed by a communication apparatus;

FIG. 12 is a flowchart showing an example of the processing executed by a terminal apparatus;

FIG. 13 is a flowchart showing an example of the processing executed by the terminal apparatus;

FIG. 14 is a flowchart showing an example of the processing executed by a communication apparatus;

FIG. 15 is a flowchart showing an example of the processing executed by the communication apparatus;

FIG. 16 is a flowchart showing an example of the processing executed by a terminal apparatus; and

FIG. 17 is a flowchart showing an example of the processing executed by the terminal apparatus.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

As a technique for causing a communication apparatus to connect to another apparatus by an information processing apparatus becomes widespread, it is demanded that convenience when the information processing apparatus causes the communication apparatus to connect to the other apparatus be improved.

### First Embodiment

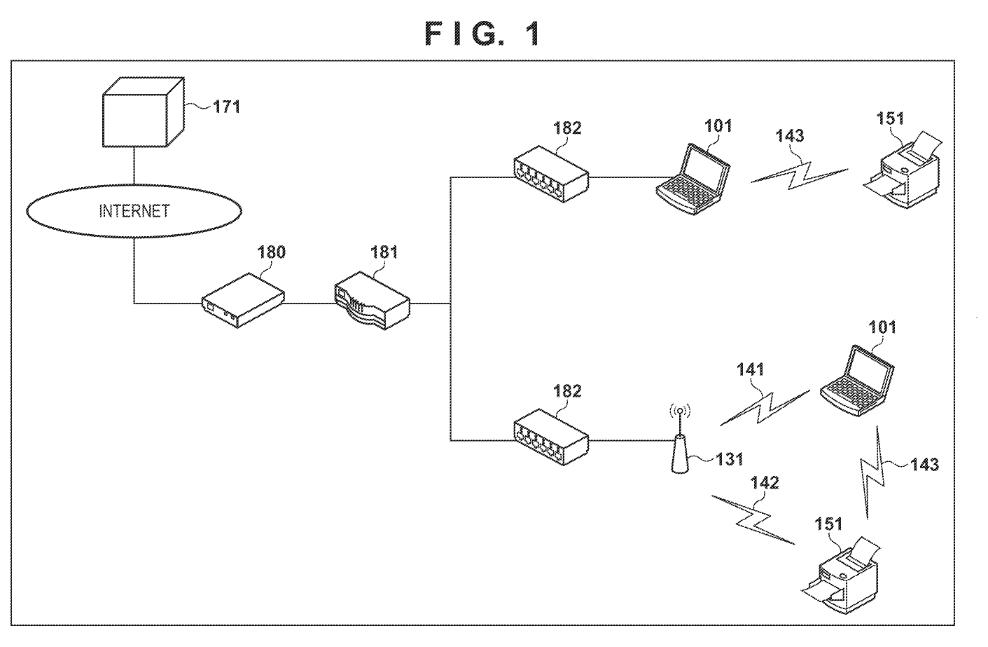

With reference to FIG. 1, the system configuration in this embodiment will be described. The communication system in this embodiment includes an information processing apparatus and a communication apparatus. As the information processing apparatus, a smartphone is exemplified in this embodiment, but the information processing apparatus is not limited thereto and various kinds of apparatuses such as a terminal apparatus, a notebook PC, a tablet terminal, a Personal Digital Assistant (PDA), and a digital camera are applicable. As the communication apparatus, a printer is exemplified in this embodiment, but the communication apparatus is not limited thereto and various kinds of apparatuses are applicable as long as they can perform wireless communication with the information processing apparatus. For example, concerning a printer, an inkjet printer, a full-color laser beam printer, a monochrome printer, and the like are applicable. Furthermore, not only a printer but also a copying machine, a facsimile apparatus, a terminal apparatus, a smartphone, a notebook PC, a tablet terminal, a PDA, a digital camera, a music playback device, a television, a smart speaker, and the like are applicable. In addition, a multi-function peripheral having a plurality of functions such as a copying function, a FAX function, and a print function is also applicable. In this embodiment, as an example, the communication apparatus is assumed to be a multi-function printer having a print function and a scanner function.

A terminal apparatus 101 is an information processing apparatus according to this embodiment. A communication apparatus 151 is a communication apparatus according to this embodiment. An access point 131 is an external apparatus that exists outside the terminal apparatus 101 and outside the communication apparatus 151. Note that the access point will be referred to as an AP in the following description. The AP 131 indicates an apparatus that operates as an AP, more specifically, for example, a device such as a wireless LAN router. Note that the AP 131 is not limited to the wireless LAN router and may be an apparatus capable of relaying wireless communication. For example, the AP 131 may be an apparatus that has an AP function for operating as an AP but does not have a router function. A Local Area Network (LAN) formed by the AP 131 includes the AP 131, the communication apparatus 151, and the terminal apparatus 101. On the other hand, a Wide Area Network (WAN) includes the AP 131 and an external server 171.

The external server 171 is a server that can provide, via the Internet, a service to an apparatus connected to the AP 131. A modem 180 is an apparatus that converts an analog signal received via the Internet into a digital signal. In accordance with the signal type, for example, when the signal is received via optical fiber connection, an Optical Network Unit is used.

A router 181 is an external apparatus that exists outside the terminal apparatus 101 and outside the communication apparatus 151. The router 181 has a function of relaying multiple terminal apparatuses 101 on networks, and assigns Internet Protocol Addresses (IP addresses) to the terminal apparatuses 101 connected to the networks to exchange packets between the networks. Network hubs 182 are external apparatuses for connecting the multiple terminal apparatuses 101 to the Internet, that is, connecting the multiple terminal apparatuses 101 to the router 181.

In this embodiment, when infrastructure connection (to be described later) is established, the terminal apparatus 101 can communicate with the communication apparatus 151 via the AP 131. Furthermore, when direct connection (to be described later) is established, the terminal apparatus 101 can directly communicate with the communication apparatus 151 without intervention of the AP 131. Note that in the following description, a connection with the AP corresponds to a connection with the network formed by the AP. Note that the AP may be capable of forming a plurality of networks at the same time. In that case, a connection with the AP may be a connection with any one of the plurality of networks formed by the AP.

In this embodiment, each of a connection 141 between the terminal apparatus 101 and the AP 131 and a connection 142 between the communication apparatus 151 and the AP 131 is a connection using a communication method based on the IEEE 802.11 series standard. More specifically, the communication method based on the IEEE 802.11 series standard is Wireless Fidelity (Wi-Fi)^{®}. A connection 143 between the terminal apparatus 101 and the communication apparatus 151 is Wi-Fi or Bluetooth^{®} Low Energy (BLE). Note that the communication method used for each connection is not limited to this form, and may be, for example, Bluetooth Classic, Wi-Fi Aware, Near Field Communication (NFC), or the like. The AP 131 and the external server 171 can communicate via the Internet. While the AP 131 is connected to the Internet, the apparatuses (the terminal apparatus 101 and the communication apparatus 151) connected to the AP 131 can also use the Internet. Note that each of the connection 141 between the terminal apparatus 101 and the AP 131 and the connection 142 between the communication apparatus 151 and the AP 131 may be a wired LAN connection.

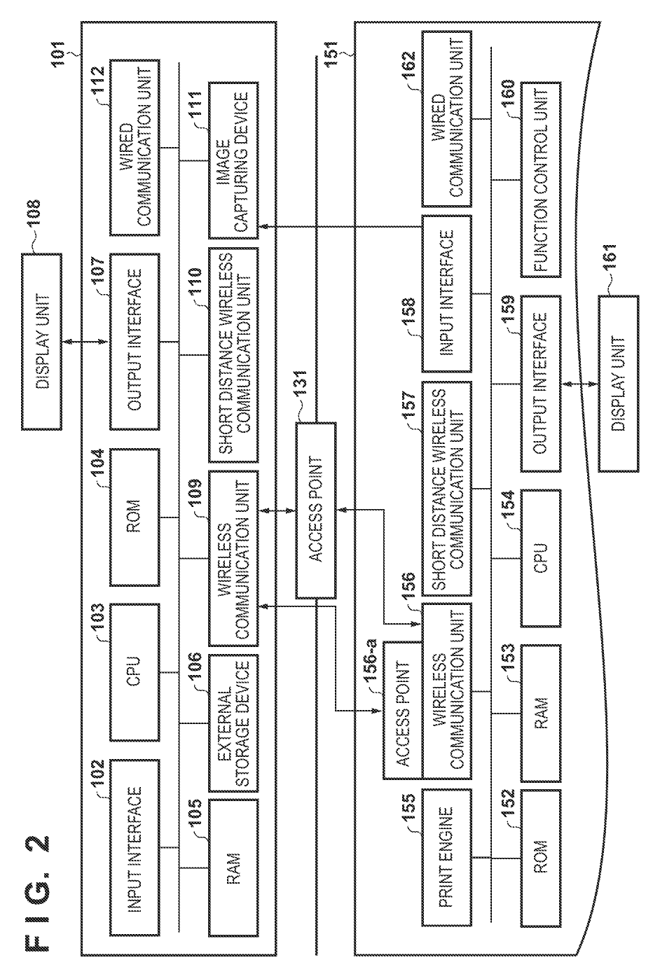

Next, the configuration of the terminal apparatus 101 according to this embodiment, and the configuration of the communication apparatus 151 that can communicate with the terminal apparatus 101 according to this embodiment will be described with reference to the block diagram of FIG. 2. The following configurations will be exemplified in this embodiment, but this embodiment is applicable to an apparatus that can communicate with the communication apparatus 151 and, in particular, functions are not limited to those shown in FIG. 2.

The terminal apparatus 101 includes an input interface 102, a CPU 103, a ROM 104, a RAM 105, an external storage device 106, an output interface 107, a display unit 108, a wireless communication unit 109, a short distance wireless communication unit 110, an image capturing device 111, a wired communication unit 112, and the like. The CPU 103, the ROM 104, the RAM 105, and the like form the computer of the terminal apparatus 101. The terminal apparatus 101 is assumed to be a device such as a smartphone, but not limited to a smartphone.

The input interface 102 is an interface for accepting a data input and an operation instruction from the user, and is formed by a physical keyboard, buttons, a touch panel, and the like. Note that the output interface 107 (to be described later) and the input interface 102 may have the same configuration, and output of a screen and acceptance of an operation from the user may be done by the same configuration.

The CPU 103 is a system control unit, and controls the overall terminal apparatus 101.

The ROM 104 stores permanent data such as control programs to be executed by the CPU 103, data tables, and an operating system (to be referred to as an OS hereinafter) program. In this embodiment, the control programs stored in the ROM 104 perform software execution control such as scheduling, task switch, and interrupt processing under the management of the embedded OS stored in the ROM 104. In this embodiment, the ROM 104 stores a setup application program (to be referred to as a setup application hereinafter). The setup application is externally installed in the terminal apparatus 101 by, for example, a store application program. The setup application is an application provided by the vender of the communication apparatus 151. Details of the setup application will be described later.

The RAM 105 is formed by a Static Random Access Memory (SRAM) or the like, which needs a backup power supply. Note that the RAM 105 can store important data such as program control variables without volatilization because the data are held by a primary battery (not shown) for data backup. In addition, a memory area for storing setting information of the terminal apparatus 101, management data of the terminal apparatus 101, and the like is also provided in the RAM 105. Furthermore, the RAM 105 is also used as the main memory and work memory of the CPU 103.

The external storage device 106 has various programs such as a print information generation program for generating print information interpretable by the communication apparatus 151, and an information transmission/reception control program for performing transmission/reception to/from the communication apparatus 151 connected via the wireless communication unit 109. The external storage device 106 also saves various kinds of information to be used by these programs, and image data obtained from another information processing apparatus or the Internet.

The output interface 107 is an interface that performs control for causing the display unit 108 to perform display of data and notification of the state of the terminal apparatus 101.

The display unit 108 is formed by a Light Emitting Diode (LED), a Liquid Crystal Display (LCD), or the like, and performs display of data and notification of the state of the terminal apparatus 101. Note that a software keyboard including keys such as numerical input keys, a mode setting key, an OK key, a cancel key, and a power key may be provided on the display unit 108 so that an input from the user is accepted via the display unit 108.

The wireless communication unit 109 is configured to be wirelessly connected to an apparatus such as the communication apparatus 151 or the AP 131 to execute data communication. For example, the wireless communication unit 109 may directly communicate with the communication apparatus 151 by wireless communication, or may communicate therewith via the AP 131 existing outside the terminal apparatus 101 and the communication apparatus 151. As the wireless communication method of the wireless communication unit 109, Wi-Fi, which is the communication method based on the IEEE 802.11 standard, is used in this embodiment, but Bluetooth Classic or the like may be used. In this embodiment, the wireless LAN is a Wi-Fi network. The AP 131 is, for example, a device such as a wireless LAN router. Note that in this embodiment, a method of connecting the terminal apparatus 101 and the communication apparatus 151 directly without intervention of the external AP is referred to as a direct connection method. A method of connecting the terminal apparatus 101 and the communication apparatus 151 via the external AP is referred to as an infrastructure connection method.

The short distance wireless communication unit 110 is configured to execute data communication with an apparatus such as the communication apparatus 151 by a short distance wireless communication method, and performs communication by a communication method different from that of the wireless communication unit 109. The short distance wireless communication unit 110 can be connected to a short distance wireless communication unit 157 in the communication apparatus 151. Note that examples of the communication method of the short distance wireless communication unit 110 are, BLE, Bluetooth Classic, Wi-Fi Aware, NFC, and the like.

The image capturing device 111 is a device that converts an image captured by an image sensor into digital data. The digital data is temporarily stored in the RAM 105. Then, the digital data is converted into a predetermined image format by a program executed by the CPU 103, and saved as image data in the external storage device 106.

The wired communication unit 112 is configured to be connected, via a wire, to an apparatus such as the communication apparatus 151 or the AP 131 to execute data communication. For example, the wired communication unit 112 performs communication via a wired LAN. In this embodiment, the communication in the wired LAN uses the Ethernet standard. Note that the wired communication unit 112 is not limited to this form, and may perform communication via, for example, a Universal Serial Bus (USB) cable.

The communication apparatus 151 includes a ROM 152, a RAM 153, a CPU 154, a print engine 155, a wireless communication unit 156, the short distance wireless communication unit 157, an input interface 158, an output interface 159, a function control unit 160, a display unit 161, a wired communication unit 162, and the like. The ROM 152, the RAM 153, the CPU 154, and the like form the computer of the communication apparatus 151.

The wireless communication unit 156 is configured to be wirelessly connected to an apparatus such as the terminal apparatus 101 or the AP 131 to execute data communication. As the wireless communication method of the wireless communication unit 156, Wi-Fi is used in this embodiment, but Bluetooth Classic or the like may be used. Note that the wireless communication unit 156 includes, as an internal AP of the communication apparatus 151, an AP 156-a which is used to connect to an apparatus such as the terminal apparatus 101. Note that this AP can be connected to the wireless communication unit 109 of the terminal apparatus 101. Note that the wireless communication unit 156 may directly communicate with the terminal apparatus 101 via the AP 156-a, or may communicate with the terminal apparatus 101 via the AP 131. The AP 156-a may be hardware functioning as an AP, or the wireless communication unit 156 may be operated as the AP 156-a by software for causing it to function as an AP. The internal AP of the communication apparatus 151 may be formed from a plurality of APs having different SSIDs or passwords. In this embodiment, the internal AP of the communication apparatus 151 includes at least a connection setting AP to be described later.

The RAM 153 is formed by a DRAM or the like that needs a backup power supply. Note that the RAM 153 can store important data such as program control variables without volatilization because the data are held by supplying power (not shown) for data backup. Furthermore, the RAM 153 is used as the main memory and work memory of the CPU 154, and operates as a reception buffer for temporarily saving print information received from the terminal apparatus 101 or the like to save various kinds of information.

The ROM 152 stores permanent data such as control programs to be executed by the CPU 154, data tables, and an OS program. In this embodiment, the respective control programs stored in the ROM 152 perform software execution control such as scheduling, task switch, and interrupt processing under the management of the embedded OS stored in the ROM 152. In addition, a memory area that stores data necessary to be held even when no power is supplied, such as setting information of the communication apparatus 151 and management data of the communication apparatus 151, is also provided in the ROM 152.

The CPU 154 is a system control unit, and controls the overall communication apparatus 151.

Based on the information saved in the RAM 153 or a print job received from the terminal apparatus 101 or the like, the print engine 155 forms an image on a print medium such as a paper sheet using a printing material such as ink and outputs the print result. At this time, the print job transmitted from the terminal apparatus 101 or the like has a large transmission data amount, and high-speed communication is required. Thus, the print engine 155 receives the print job via the wireless communication unit 156 capable of performing communication at a higher speed than the short distance wireless communication unit 157.

The short distance wireless communication unit 157 is configured to perform communication with an apparatus such as the terminal apparatus 101 by a short distance wireless communication method. Note that examples of the communication method of the short distance wireless communication unit 157 are BLE, Bluetooth Classic, Wi-Fi Aware, and the like.

The input interface 158 is an interface for accepting a data input and an operation instruction from the user, and is formed by a physical keyboard, buttons, a touch panel, and the like. Note that the output interface 159 (to be described later) and the input interface 158 may have the same configuration, and output of a screen and acceptance of an operation from the user may be done by the same configuration. The output interface 159 is an interface that performs control for causing the display unit 161 to perform display of data and notification of the state of the communication apparatus 151.

The function control unit 160 manages the function operation as to whether to simultaneously operate the functions of the communication apparatus 151.

The display unit 161 is formed by a Light Emitting Diode (LED), a Liquid Crystal Display (LCD), or the like, and performs display of data and notification of the state of the communication apparatus 151. Note that a software keyboard including keys such as numerical input keys, a mode setting key, an OK key, a cancel key, and a power key may be provided on the display unit 161 so that an input from the user is accepted via the display unit 161.

The wired communication unit 162 is configured to be connected, via a wire, to an apparatus such as the terminal apparatus 101 or the AP 131 to execute data communication. For example, the wired communication unit 162 performs communication via a wired LAN. Note that the wired communication unit 162 is not limited to this form, and may perform communication via, for example, a USB cable.

### Direct Connection Method

Direct connection indicates a form in which apparatuses are wirelessly connected directly (that is, by Peer to Peer) without intervention of an external apparatus such as the AP 131. Direct connection is also called Peer to Peer connection (P2P connection). As one connection mode, the communication apparatus 151 can operate in a mode (direct connection mode) for communication by direct connection. In Wi-Fi communication, the mode for communication by direct connection includes a plurality of modes such as a software AP mode and a Wi-Fi Direct (WFD) mode.

A mode in which direct connection is executed by WFD is called a WFD mode. WFD is a standard developed by Wi-Fi Alliance and is a standard included in the IEEE 802.11 series communication standards. In the WFD mode, a device serving as a communication partner is searched for by a device search command, then the roles of a P2P group owner (GO) and P2P client are decided, and remaining wireless connection processing is performed. The group owner corresponds to a Wi-Fi master station (master unit), and the client corresponds to a Wi-Fi slave station (slave unit). This role making corresponds to, for example, GO Negotiation in P2P. Note that in the WFD mode in a state before role making is performed, the communication apparatus 151 is neither the master station nor the slave station. More specifically, first, one of devices to communicate with each other issues a device search command and searches for a device to be connected in the WFD mode. After the other device serving as a communication partner is searched, the devices confirm information about services and functions that can be supplied by the respective devices. Note that the device supply information confirmation is an option and is dispensable. The device supply information confirmation phase corresponds to, for example, P2P Provision Discovery. Then, the devices confirm the device supply information and decide, as roles, which device serves as a P2P client and which device serves as a P2P group owner. After the client and the group owner are decided, the devices exchange parameters for performing WFD communication. Based on the exchanged parameters, the P2P client and the P2P group owner perform remaining wireless connection processing and IP connection processing. Note that in the WFD mode, the communication apparatus 151 may always operate as the GO without executing the above-described GO Negotiation. That is, the communication apparatus 151 may operate in the WFD mode that is an Autonomous GO mode. The state in which the communication apparatus 151 operates in the WFD mode is, for example, a state in which WFD connection is not established but the communication apparatus 151 operates as the GO, or a state in which WFD connection is established and the communication apparatus 151 operates as the GO.

In the software AP mode, one device (for example, the terminal apparatus 101) among devices (for example, the terminal apparatus 101 and the communication apparatus 151) to communicate with each other serves as a client that plays a role of requesting various services. The other device implements the function of an AP in Wi-Fi by software setting. The software AP corresponds to a Wi-Fi master station, and the client corresponds to a Wi-Fi slave station. In the software AP mode, the client searches for a device serving as a software AP by a device search command. After the software AP is searched, the client and the software AP perform remaining wireless connection processing (establishment of wireless connection and the like) and then IP connection processing (assignment of an IP address and the like). Note that commands and parameters transmitted/received when implementing wireless connection between the client and the software AP suffice to be those defined by the Wi-Fi standard, and a description thereof will be omitted here.

In this embodiment, in a case where the communication apparatus 151 establishes and maintains direct connection, it operates as a master station in a network to which the communication apparatus 151 belongs. Note that the master station is an apparatus that creates a wireless network, and is an apparatus that provides a slave station with parameters used in connection to the wireless network. The parameters used in connection to the wireless network are, for example, parameters about a channel used by the master station. The slave station receives the parameters and is then connected to the wireless network created by the master station using the channel used by the master station. In the direct connection mode, the communication apparatus 151 operates as the master station so that the communication apparatus 151 can thus decide a specific frequency band and channel to be used for communication in the direct connection mode. In this embodiment, the communication apparatus 151 can use a channel corresponding to the 2.4-GHz frequency band and a channel corresponding to the 5-GHz frequency band for communication in the direct connection mode. In this embodiment, however, the communication apparatus 151 does not use a channel corresponding to the Dynamic Frequency Selection (DFS) band in the 5-GHz frequency band for communication in the direct connection mode. In other words, the communication apparatus 151 uses only a channel corresponding to a frequency band other than the DFS band in the 5-GHz frequency band for communication in the direct connection mode. Note that if a radar wave in the frequency band corresponding to the channel is detected in a state in which a channel corresponding to the DFS band is used, the channel currently used needs to be changed. The frequency band in which the channel can be changed by detecting a radar wave is called the DFS band. Note that if, for example, a radio chip corresponding to a DFS function is used, it may be possible to use a channel corresponding to the DFS band in the 5-GHz frequency band for communication in the direct connection mode. Note that the channel, which is decided as the channel used in the direct connection mode, is used in the communication via direct connection. Furthermore, this channel is also used to transmit a Beacon signal and a response to a received command as a master station. That is, this channel is used not only for communication processing in the direct connection mode in a state in which direct connection is established, but also for communication processing in the direct connection mode in a state in which direct connection is not established.

Note that the user may be capable of setting whether to use, in the direct connection mode, a channel corresponding to a 2.4-GHz frequency band or a channel corresponding to a 5-GHz frequency band. Furthermore, by accepting a designation of a channel number from the user, the user may be capable of setting the channel number to be used in the direct connection mode. Alternatively, the channel to be used in the direct connection mode may be set in advance in the communication apparatus 151, rather than being arbitrarily set by the user.

Note that the form in which the communication apparatus 151 can use a 2.4-GHz frequency band and a 5-GHz frequency band has been described, but the present disclosure is not limited to this form. The communication apparatus 151 may be capable of using another frequency band, and the other frequency band may be used in the processing where the 2.4-GHz frequency band or 5-GHz frequency band is used in this embodiment. For example, since a 60-GHz frequency band is available in the IEEE 802.11ad standard, the 60-GHz frequency band may be used as the other frequency band described above.

### Infrastructure Connection Method

Infrastructure connection is a connection form in which devices (for example, the terminal apparatus 101 and the communication apparatus 151) to communicate with each other are connected to an AP (for example, the AP 131) that controls a network of the devices, and the devices communicate with each other via the AP. As one connection mode, the communication apparatus 151 can also operate in a mode (infrastructure connection mode) for communication by infrastructure connection.

In infrastructure connection, each device searches for an AP by a device search command. After an AP is searched, the device and the AP perform remaining wireless connection processing (establishment of wireless connection and the like) and then IP connection processing (assignment of an IP address and the like). Note that commands and parameters transmitted/received when implementing wireless connection between the device and the AP suffice to be those defined by the Wi-Fi standard, and a description thereof will be omitted here.

In this embodiment, when the communication apparatus 151 operates in the infrastructure connection, the AP 131 operates as a master station and the communication apparatus 151 operates as a slave unit. That is, in this embodiment, infrastructure connection means connection between the communication apparatus 151 operating as a slave unit and the apparatus operating as a master unit. In a case where the communication apparatus 151 establishes infrastructure connection and the terminal apparatus 101 also establishes infrastructure connection to the AP 131, the communication apparatus 151 and the terminal apparatus 101 can communicate with each other via the AP 131. Since the AP 131 decides a channel to be used for communication in infrastructure connection, the communication apparatus 151 executes communication in infrastructure connection using the channel decided by the AP 131. In this embodiment, the communication apparatus 151 can use a channel corresponding to the 2.4-GHz frequency band and a channel corresponding to the 5-GHz frequency band for communication in infrastructure connection. Note that the communication apparatus 151 can also use a channel corresponding to the DFS band in the 5-GHz frequency band for communication in infrastructure connection. Note also that to communicate with the communication apparatus 151 via the AP 131, the terminal apparatus 101 needs to recognize that the communication apparatus 151 belongs to a network which is formed by the AP 131 and to which the terminal apparatus 101 belongs.

### Simultaneous Operation

The communication apparatus 151 according to this embodiment can execute an operation by the infrastructure mode and an operation by the direct connection mode simultaneously (in parallel). Accordingly, the communication apparatus 151 can maintain the connection for communication by the infrastructure mode and the connection for communication by the direct connection mode simultaneously (in parallel). In other words, the communication apparatus 151 can establish Wi-Fi connection for which the self-apparatus serves as a slave unit, and Wi-Fi connection for which the self-apparatus serves as a master unit in parallel. Hereinafter, an operation in which infrastructure connection and direct connection are established simultaneously (in parallel) so that communication via the infrastructure connection and communication via the direct connection can be executed simultaneously (in parallel) will be referred to as a simultaneous operation. In other words, the simultaneous operation is an operation in which the communication apparatus 151 executes the operation as a master unit (Group Owner or AP) and the operation as a slave unit in parallel.

Each of communication by the infrastructure mode and communication by the direct connection mode is executed using a specific frequency band (specific channel). Hence, in each of the communication by the infrastructure mode and the communication by the direct connection mode, the channel to be used for communication/connection between apparatuses needs to be decided first before the communication is started. Note that in a form in which a plurality of channels are simultaneously assigned to one radio IC chip for communication, the configurations of the apparatuses that execute communication and the processing operations executed by the apparatuses become complicated. Therefore, for example, when the communication apparatus 151 executes the simultaneous operation, it is desirable to use a common channel in communication in the respective modes. That is, even when the communication apparatus 151 executes the simultaneous operation, it is desirable to use only one channel. Accordingly, in this embodiment, the wireless communication unit 156 includes only a single radio IC chip that implements communication by a predetermined channel, and the communication apparatus 151 does not execute communication using a plurality of channels simultaneously.

### Connection Setting Mode

The communication apparatus 151 can operate in the connection setting mode. A trigger for the communication apparatus 151 to start an operation in the connection setting mode may be, for example, pressing a connection setting mode button by the user or activating (turning on) the communication apparatus 151 for the first time after arrival. The connection setting mode button may be a hardware button of the communication apparatus 151 or a software button displayed on the display unit 161 by the communication apparatus 151.

When the communication apparatus 151 starts an operation in the connection setting mode, it enables both Wi-Fi communication and BLE communication. More specifically, as Wi-Fi communication enabling processing, the communication apparatus 151 enables an internal AP (connection setting AP) of the communication apparatus 151 that is dedicated to the connection setting mode. Then, the communication apparatus 151 can establish direct connection to the terminal apparatus 101 by Wi-Fi. Connection information (SSID and password) for connection to the connection setting AP is held in advance in the setup application installed in the terminal apparatus 101 so that the terminal apparatus 101 recognizes in advance the connection information for connection to the connection setting AP. Note that a form may be adopted in which no encryption method is set for the connection setting AP so no password is required to connect to the AP. Therefore, unlike the connection information of the AP enabled in the direct connection mode, the connection information for connection to the connection setting AP cannot be changed arbitrarily by the user. Note that in the connection setting mode, the communication apparatus 151 may be connected to the terminal apparatus 101 not by normal Wi-Fi but by WFD. That is, the communication apparatus 151 may operate as a group owner and receive a setting command from the terminal apparatus 101 by WFD communication.

Note that when communication is executed via wireless connection between the terminal apparatus 101 and the communication apparatus 151 operating in the connection setting mode, the terminal apparatus 101 may use, as a protocol used for communication, Internet Protocol version 4 (IPv4) or Internet Protocol version 6 (IPv6). For example, if IPv6 is set in the terminal apparatus 101 but the communication apparatus 151 can only execute communication using IPv4, the communication may not be executable. That is, before starting the communication, predetermined processing may be executed for determining whether the communication apparatus 151 can use the protocol used for communication by the terminal apparatus 101. Note that a case where IPv4 is set in the terminal apparatus 101 as the protocol used for communication by the terminal apparatus 101 is a case where communication using IPv4 by the wireless communication unit 109 is enabled in the terminal apparatus 101. Similarly, a case where IPv6 is set in the terminal apparatus 101 as the protocol used for communication by the terminal apparatus 101 is a case where communication using IPv6 by the wireless communication unit 109 is enabled in the terminal apparatus 101.

### Connection Setting Processing

In this embodiment, the terminal apparatus 101 executes setting (connection setting) for causing the communication apparatus 151 to operate in the infrastructure connection mode by using wireless communication with the communication apparatus 151. The connection setting processing according to this embodiment is executed by wireless communication, and is thus called a cableless setup (CLS). The connection setting processing will be sometimes referred to as the first setup as will be described later. Note that the connection setting processing may be executed using wired communication. The communication apparatus 151 executes the wireless connection processing while it operates in the connection setting mode, which is a mode for executing the wireless connection processing. The terminal apparatus 101 executes the connection setting processing while the setup application is running. The setup application is an application program for setting the AP to be connected to the communication apparatus 151, and for causing the communication apparatus 151 to print image data, document data, or the like in the terminal apparatus 101.

Note that the setup application may have another function in addition to a function for executing the connection setting processing, which is processing of setting the AP to be connected to the communication apparatus 151, by transmitting a setting command to the communication apparatus 151, and a function of causing the communication apparatus 151 to execute printing. For example, the setup application may have a function of causing the communication apparatus 151 to scan a document set therein if the communication apparatus 151 has a scan function, a function of performing another setting of the communication apparatus 151, a function of checking the state (status) of the communication apparatus 151, or the like. The setup application may have a function for executing the connection setting processing without having other functions such as the function of causing the communication apparatus 151 to execute printing. The function of causing the communication apparatus 151 to execute printing is, more specifically, a function of transmitting a print job for causing the communication apparatus 151 to execute printing to the communication apparatus 151. The function of causing the communication apparatus 151 to scan a document set therein is, more specifically, a function of transmitting a scan job for causing the communication apparatus 151 to execute scanning to the communication apparatus 151. The function of checking the state of the communication apparatus 151 is, more specifically, a function of acquiring information indicating the status of the communication apparatus 151 from the communication apparatus 151 and displaying it. The setup application is assumed to be an application program.

In the following description, the processing executed by the setup application is implemented, in practice, when the CPU 103 reads out the setup application stored in the ROM 104 into the RAM 105 and executes it. When connecting the AP 131 and the communication apparatus 151 to each other and causing the communication apparatus 151 to operate in the infrastructure connection mode, the terminal apparatus 101 wirelessly transmits an infrastructure setting command for causing the communication apparatus 151 to operate in the infrastructure connection mode to the communication apparatus 151. The infrastructure setting command includes, for example, information concerning the AP 131. The information concerning the AP 131 is, for example, the Service Set Identifier (SSID) of the AP 131, a password for connecting to the AP 131, information about the frequency band used by the AP 131, and the like. After infrastructure connection by Wi-Fi is established between the terminal apparatus 101 and the communication apparatus 151 by the connection setting processing, the terminal apparatus 101 and the communication apparatus 151 can communicate with each other via the established connection. More specifically, for example, the terminal apparatus 101 can transmit, to the communication apparatus 151 via the established connection, a print job for causing the communication apparatus 151 to execute printing or a scan job for causing the communication apparatus 151 to execute scanning. In addition, after infrastructure connection is established, the communication apparatus 151 can communicate with the Internet via the AP 131. As an example, the communication apparatus 151 can receive an apparatus update notification from a specific server, download print data, or upload information of the communication apparatus 151.

### Wireless Profile

A wireless profile is information stored and managed by the OS of the terminal apparatus 101, and including the connection information of the AP having connected to the terminal apparatus 101. For example, the wireless profile is used for a reconnection function, which is a function of, when the connection between the terminal apparatus 101 and the AP is disconnected, automatically reestablishing the connection by the OS.

### Processing Executed by Terminal Apparatus 101 and Communication Apparatus 151

In this embodiment, the setup application can execute the network setup (to be referred to as the first setup hereinafter) of the communication apparatus 151 via wireless connection between the terminal apparatus 101 and the communication apparatus 151 operating in the connection setting mode. In other words, the first setup is a setup method of connecting the communication apparatus 151 and the AP by the setup application transmitting the setting information from the terminal apparatus 101 to the communication apparatus 151 via wireless communication. More specifically, based on that a connection setting instruction (user instruction) for connecting the communication apparatus 151 to the AP is accepted, the setup application causes the terminal apparatus 101 to operate as follows. After the terminal apparatus 101 is connected to the communication apparatus 151 operating in the connection setting mode, it acquires, from the communication apparatus 151, a list of APs to which the communication apparatus 151 can connect. If the AP 131 having connected to the terminal apparatus 101 before the terminal apparatus 101 is connected to the communication apparatus 151 is included in the list, the setting information of the AP 131 is transmitted to the communication apparatus 151. Then, the communication apparatus 151 connects to the AP 131 by using the setting information of the AP 131 received from the terminal apparatus 101. Note that the setting information includes a password for connecting to the AP 131.

When acquiring the AP list from the communication apparatus 151, the terminal apparatus 101 may designate the information (SSID or channel) of the AP 131 with respect to the communication apparatus 151. For example, some AP may be set to stop a beacon signal for notifying the SSID. Hereinafter, setting to stop a beacon signal will be referred to as SSID stealth setting. In this manner, even if the AP is in the SSID stealth setting, when the terminal apparatus 101 designates the information of the AP 131 with respect to the communication apparatus 151, the communication apparatus 151 can find the target SSID by performing a search while designating the SSID. When the terminal apparatus 101 designates the channel of the AP 131, the communication apparatus 151 can search for only the target channel, and this reduces the search time for the AP 131.

Note that there is a case where, when executing the first setup, the wireless profile corresponding to the predetermined AP to be connected to the communication apparatus 151 is saved in advance in the terminal apparatus 101 before the setup application accepts a predetermined operation (predetermined connection setting instruction) for the first setup from the user. In this case, the setup application can execute the first setup without accepting an input of the password from the user.

Note that the communication apparatus 151 can connect to the AP using a method other than the first setup. Each of the second setup and the third setup, which is a method other than the first setup, is the network setup performed without the setup application transmitting the setting information from the terminal apparatus 101 to the communication apparatus 151 via wireless communication. More specifically, for example, the second setup is the network setup by push-button Wi-Fi Protected Setup (WPS). The second setup may be the network setup by PIN-code WPS. Alternatively, the second setup may be the network setup by AOSS, Easy Wireless Start, or the like other than WPS. The second setup may be the network setup performed by establishing, using a wireless LAN, a connection between the communication apparatus 151 and the AP selected from the APs searched by the communication apparatus 151 by the user through an operation on the communication apparatus 151. The third setup as the method other than the first setup is the network setup performed by establishing, using a wired LAN, a connection between the AP and the communication apparatus 151. Note that the third setup may be the network setup performed by establishing, using USB, a connection between the terminal apparatus 101 and the communication apparatus 151.

As described above, in the first setup, after the terminal apparatus 101 is connected to the communication apparatus 151 operating in the connection setting mode, it acquires, from the communication apparatus 151, a list of APs to which to the communication apparatus 151 can connect. More specifically, the terminal apparatus 101 instructs the communication apparatus 151 to search for nearby APs, and acquires an AP list from the communication apparatus 151 as a response. Here, for example, assume a case where after the terminal apparatus 101 is connected to the communication apparatus 151 operating in the connection setting mode, it designates the AP 131 having connected to the terminal apparatus 101 with respect to the communication apparatus 151, and instructs the communication apparatus 151 to search for nearby APs. In this case, if the terminal apparatus 101 acquires an AP list including the AP 131 from the communication apparatus 151, it is assumed that the communication apparatus 151 can connect to the AP 131. Accordingly, by transmitting the setting information of the AP 131 from the terminal apparatus 101 to the communication apparatus 151, the communication apparatus 151 can be connected to the AP 131.

However, the communication apparatus 151 may not support the authentication method used by the AP 131. The authentication method used by the AP 131 is the authentication method used for authentication between the AP 131 and another apparatus. In this case, for example, even if the AP 131 is designated in the above-described case, it is assumed that the communication apparatus 151 transmits an AP list not including the AP 131 to the terminal apparatus 101 because it does not support the authentication method of the AP 131. That is, although the terminal apparatus 101 designates the AP 131 having connected to the terminal apparatus 101 with respect to the communication apparatus 151 and instructs the communication apparatus 151 to search for the AP, an AP list including the AP 131 cannot be acquired from the communication apparatus 151. Next, for example, assume a form where an AP list including the AP 131 is transmitted to the terminal apparatus 101 even though the communication apparatus 151 does not support the authentication method used by the AP 131. In this form, for example, even if the terminal apparatus 101 transmits the setting information of the AP 131, it is assumed that the communication apparatus 151 fails to connect to the AP 131 because it does not support the authentication method of the AP 131.

In this manner, if the communication apparatus 151 does not support the authentication method used by the AP 131, even if the terminal apparatus 101 designates the AP 131 and causes the communication apparatus 151 to search for the AP 131, the communication apparatus 151 cannot connect to the AP 131. Hence, if the communication apparatus 151 does not support the authentication method used by the AP 131, there is no need to cause the communication apparatus 151 to search for the AP 131. If this search is executed, it takes time for processing of the first setup.

Therefore, in this embodiment, the setup application causes the CPU 103 of the terminal apparatus 101 to operate as follows. The CPU 103 accepts a connection setting instruction for performing the connection setting of the communication apparatus 151. The CPU 103 transmits, to the communication apparatus 151, an AP search instruction for causing the communication apparatus 151 to execute AP search processing for searching for the network formed by the AP 131 to which the terminal apparatus 101 has been connected at least at the timing of accepting the connection setting instruction. Here, based on that the communication apparatus 151 does not support the authentication method used in the network formed by the AP 131, the CPU 103 controls not to transmit the AP search instruction to the communication apparatus 151. On the other hand, based on that the communication apparatus 151 supports the authentication method used in the network formed by the AP 131, the CPU 103 controls to transmit the AP search instruction to the communication apparatus 151.

In this manner, in this embodiment, based on whether the communication apparatus 151 supports the authentication method used in the network formed by the AP 131, the CPU 103 controls whether to transmit the search instruction for the AP 131. With this operation, if the communication apparatus 151 does not support the authentication method used by the AP 131, the AP 131 is not searched for. Thus, the time for the first setup can be shortened. That is, it is possible to improve convenience when the terminal apparatus 101 causes the communication apparatus 151 to connect to another apparatus.

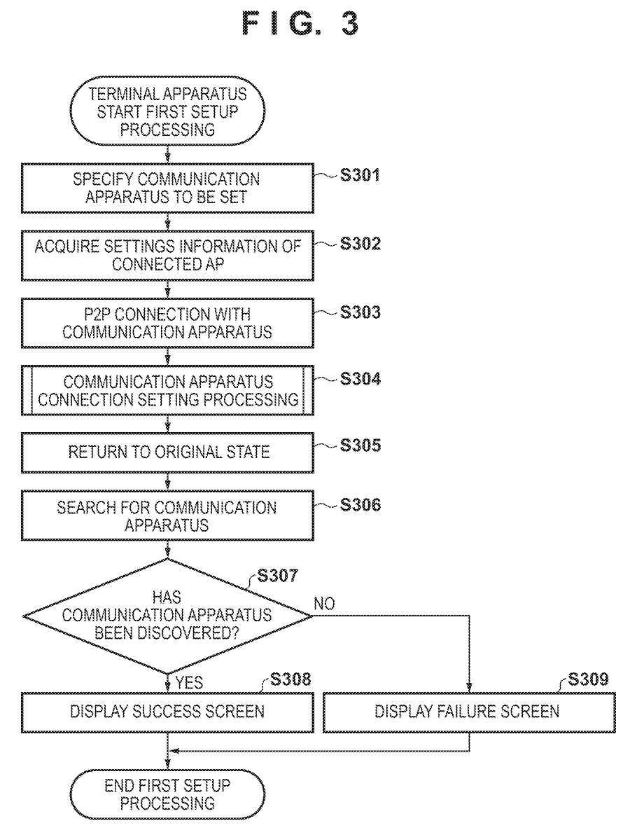

FIG. 3 is a flowchart illustrating the overall first setup processing of the communication apparatus 151, which is executed by the terminal apparatus 101. This flowchart is implemented when the CPU 103 reads out the program stored in the ROM 104 into the RAM 105 and executes it. Note that in this embodiment, the terminal apparatus 101 executes the processing using the setup application. This flowchart is started based on that the user made the above-described connection setting instruction on a screen displayed by the setup application. For example, when the CPU 103 accepts a setup application activation instruction (user operation) as the connection setting instruction via, for example, the display unit 108, it starts the first setup processing.

In step S301, the CPU 103 searches for APs existing around the terminal apparatus 101. The CPU 103 then specifies the communication apparatus 151 operating in the connection setting mode (as the connection setting AP). More specifically, the CPU 103 searches for a beacon which is generated by the communication apparatus 151 operating in the connection setting mode and includes the SSID corresponding to the connection setting mode. If the SSID corresponding to the connection setting mode is included in the search results, the CPU 103 specifies the communication apparatus 151 corresponding to the SSID as the first setup target apparatus (to be referred to as the target apparatus hereinafter) targeted for setting. Note that if multiple communication apparatuses 151 are discovered, the communication apparatus 151 which is discovered first may be specified as the target apparatus, or the communication apparatus 151 selected by the user from the multiple discovered communication apparatuses 151 may be specified as the target apparatus. In the following description, processing for the first setup is performed for the communication apparatus 151 specified as the target apparatus.

In addition, in step S301, the CPU 103 searches for APs existing around the terminal apparatus 101. The CPU 103 then holds the information (such as the SSID) of the discovered AP as an AP information list in a memory such as the RAM 105.

In step S302, the CPU 103 specifies the SSID of the AP 131 connected to the terminal apparatus 101, and the authentication method used by the AP 131 connected to the terminal apparatus 101. In addition, the CPU 103 acquires the password corresponding to the SSID of the AP 131 connected to the terminal apparatus 101 from a wireless profile.

In step S303, the CPU 103 disconnects the connection by Wi-Fi communication with the AP 131 connected to the terminal apparatus 101 using the wireless communication unit 109. After that, the CPU 103 changes the connection destination of the wireless communication unit 109 of the terminal apparatus 101 to the communication apparatus 151 operating in the connection setting mode. With the processing in step S303, a connection between the terminal apparatus 101 and the communication apparatus 151 is established.

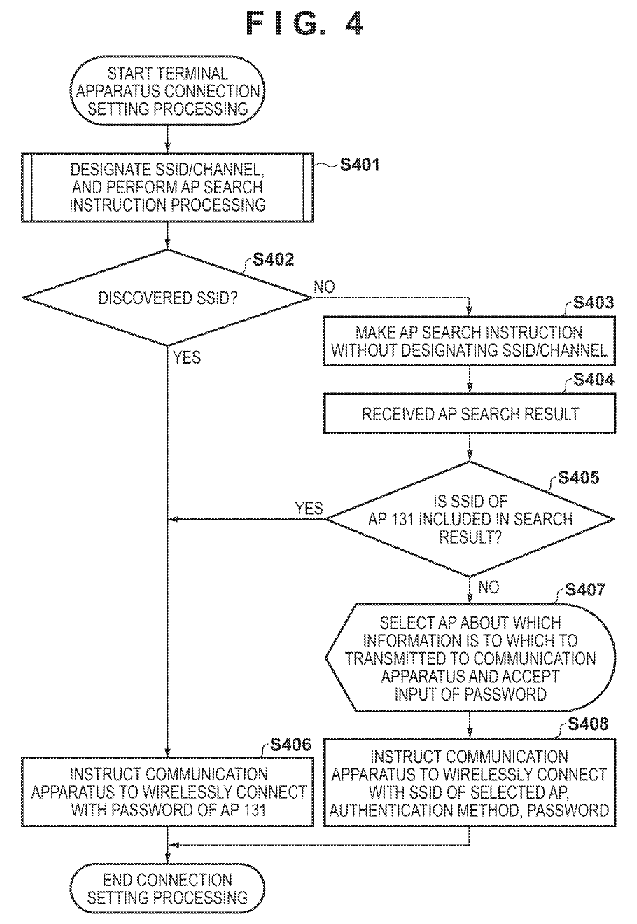

In step S304, the CPU 103 executes connection setting processing. That is, in step S304, the CPU 103 executes the first setup for connecting the communication apparatus 151 to the AP 131. Details of the connection setting processing will be described later with reference to FIG. 4.

In step S305, the CPU 103 returns to be connected to the AP 131 by using the SSID of the AP 131, the information indicating the authentication method, and the password which are acquired in step S302. With the processing in step S305, the connection between the terminal apparatus 101 and the communication apparatus 151 is established.

In step S306, the CPU 103 searches for the communication apparatus 151 on the network (the network formed by the AP 131) to which the terminal apparatus 101 belongs. If the communication apparatus 151 and the terminal apparatus 101 are connected to the same AP 131 as a result of executing the connection setting processing, the communication apparatus 151 is discovered through this search.

In step S307, the CPU 103 determines whether the communication apparatus 151 has been discovered through the search in step S306. If YES is determined in step S307, the CPU 103 advances to step S308. If NO is determined in step S307, the CPU 103 advances to step S309. More specifically, the CPU 103 specifies whether the communication apparatus 151 to which the setting information has been transmitted by the first setup processing is included in one or multiple apparatuses discovered through the search in step S306. If it is specified that the communication apparatus 151 is included, the CPU 103 determines YES in this determination. That is, if no apparatus is discovered through the search in step S314, or if the communication apparatus 151 to which the setting information has been transmitted by the first setup processing is not included in one or multiple discovered apparatuses, the CPU 103 determines NO in this determination.

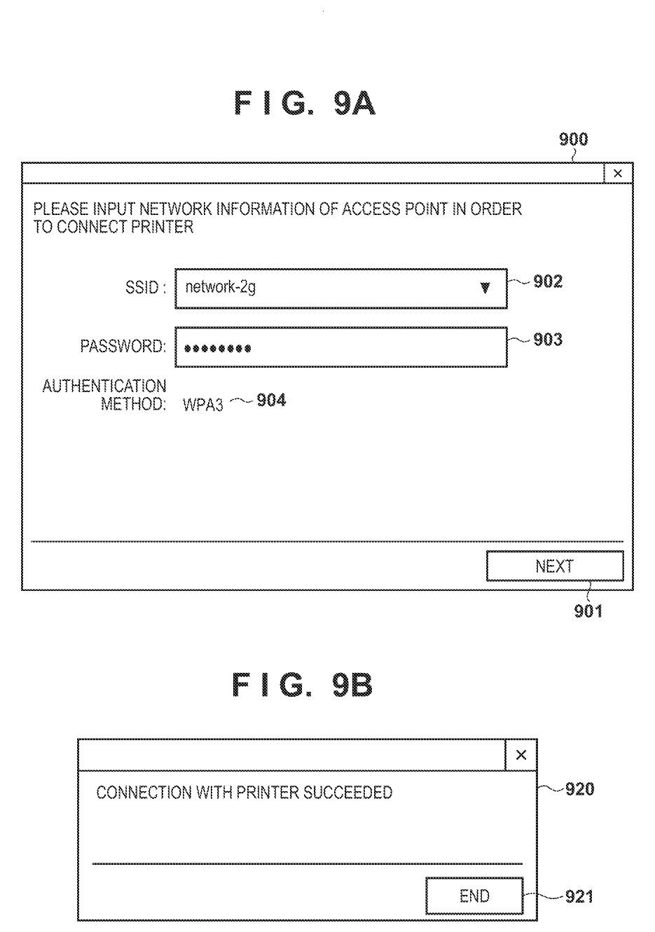

In step S308, the CPU 103 displays a success screen on the display unit 108, which is a screen corresponding to a fact that the communication apparatus 151 has been discovered through the search in step S306. Here, for example, a success screen 920 shown in FIG. 9B is displayed on the display unit 108. For example, the success screen 920 includes a message indicating that the communication apparatus 151 has been discovered, or a message indicating that the connection with the communication apparatus 151 has been successful. If an end button 921 included in the success screen 920 is pressed, the processing of this flowchart ends.

Note that in the case where the communication apparatus 151 has been discovered through the search in step S306, the CPU 103 may acquire capability information concerning the capability of the communication apparatus 151 from the communication apparatus 151. The capability information may be used in print setting processing for performing setting of a print job transmitted to the communication apparatus 151, or scan setting processing for performing setting of a scan job transmitted to the communication apparatus 151. The capability information is, for example, information indicating the sheet type available for printing, information indicating whether a scanning operation can be executed, or the like.

In the case where the communication apparatus 151 has been discovered through the search in step S306, for example, the CPU 103 may execute processing for installing a printer driver corresponding to the communication apparatus 151. More specifically, for example, the CPU 103 may install an installer for installing a printer driver corresponding to the communication apparatus 151, and install the printer driver using the installer.

In step S309, the CPU 103 displays a failure screen on the display unit 108, which is a screen corresponding to a fact that the communication apparatus 151 could not be discovered through the search in step S306. Here, for example, a failure screen 930 shown in FIG. 9C is displayed on the display unit 108. For example, the failure screen 930 includes a message indicating that the communication apparatus 151 could not be discovered, or a message indicating that the connection with the communication apparatus 151 has failed. If an end button 931 included in the failure screen 930 is pressed, the processing of this flowchart ends.

Note that in this embodiment, when establishing the connection between the terminal apparatus 101 and the communication apparatus 151, the CPU 103 disconnects the connection between the terminal apparatus 101 and the AP 131 in step S303, but the present disclosure is not limited to this. The CPU 103 may be configured to establish the connection between the terminal apparatus 101 and the communication apparatus 151 without disconnecting the connection between the terminal apparatus 101 and the AP 131 in step S303. That is, the CPU 103 may establish the connection between the terminal apparatus 101 and the communication apparatus 151 using a communication method different from Wi-Fi communication while maintaining Wi-Fi communication between the terminal apparatus 101 and the AP 131. More specifically, the CPU 103 may use the short distance wireless communication unit 110 to establish the connection between the terminal apparatus 101 and the communication apparatus 151 by short distance wireless communication. This allows establishing the connection between the terminal apparatus 101 and the communication apparatus 151 while maintaining Wi-Fi communication between the terminal apparatus 101 and the AP 131. Note that, for example, if the connection between the terminal apparatus 101 and the AP 131 is not disconnected in step S303, the CPU 103 skips the processing in step S305.

FIG. 4 is a flowchart showing an example of the connection setting processing executed by the terminal apparatus 101. This flowchart is implemented when the CPU 103 reads out the program stored in the ROM 104 into the RAM 105 and executes it. Note that in this embodiment, the terminal apparatus 101 executes the processing using the setup application. This flowchart corresponds to step S304.

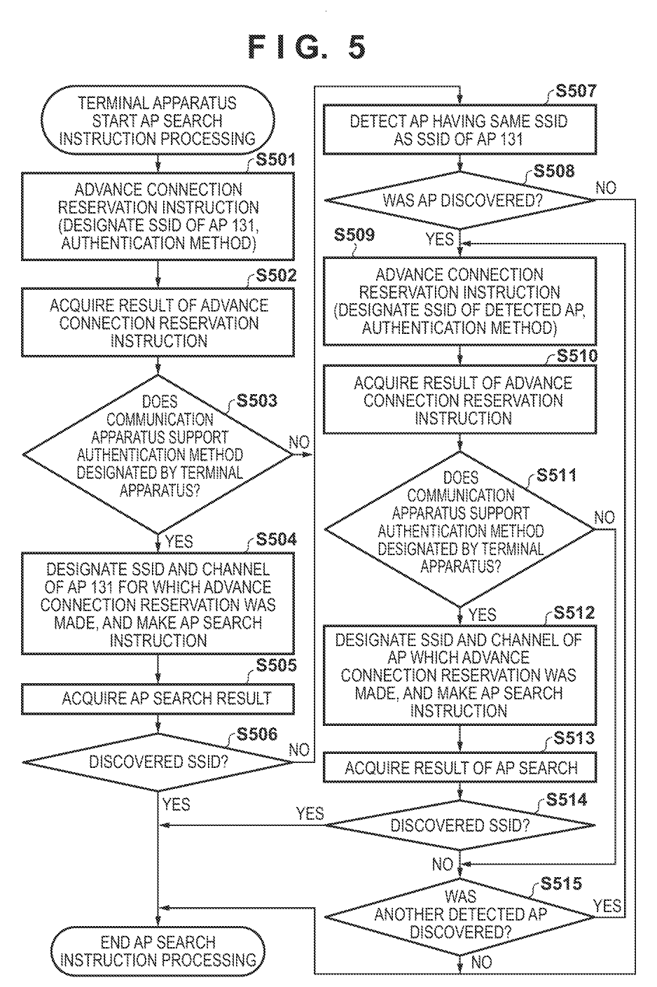

In step S401, the CPU 103 designates the SSID of the AP and the channel, and executes AP search instruction processing for causing the communication apparatus 151 to search for the AP. In this embodiment, as will be described later, in the AP search instruction processing, the CPU 103 first issues a connection reservation instruction designating the SSID of the AP 131 and the channel to the communication apparatus 151. In this embodiment, simply receiving the connection reservation instruction does not cause the communication apparatus 151 to search for the AP 131 corresponding to the designated SSID or connect to the network formed by the AP 131 corresponding to the designated SSID. The communication apparatus 151 searches for the AP 131 based on receiving a search instruction (to be described later) after receiving the connection reservation instruction. Then, based on receiving a wireless connection instruction (to be described later), the communication apparatus 151 connects to the network formed by the AP 131 corresponding to the designated SSID. When the connection reservation instruction is received, the communication apparatus 151 executes processing based on receiving the connection reservation instruction, and transmits the processing result to the terminal apparatus 101 as the result of the connection reservation instruction. Accordingly, after the connection reservation instruction is issued, the CPU 103 receives the result of the connection reservation instruction from the communication apparatus 151, and determines whether the communication apparatus 151 supports the authentication method of the AP 131. If the communication apparatus 151 supports the authentication method of the AP 131, the CPU 103 issues a search instruction for the AP 131 to the communication apparatus 151. Then, the CPU 103 acquires the search result of the AP 131 from the communication apparatus 151. The search result is a list of APs discovered by the communication apparatus 151. The list of APs is a list of the information of the AP discovered by the communication apparatus 151. The list of APs includes the information of the AP such as the SSID of the AP discovered by the communication apparatus 151, the channel, and the information indicating the authentication method. When there are multiple identical SSIDs in the same channel, the list of APs (to be referred to as an AP information list hereinafter) includes information of multiple APs. During this processing, processing of designating the AP to be connected to the communication apparatus 151 is also executed. Details of step S401 will be described later with reference to FIG. 5.

In step S402, the CPU 103 determines whether the information of the AP 131 is included in the AP information list as the result of the AP search instruction processing in step S401. If it is determined that the information of the AP 131 is included, the CPU 103 advances to step S406. On the other hand, if it is determined that the information of the AP 131 is not included, the CPU 103 advances to step S403. That is, in step S402, the CPU 103 determines whether the communication apparatus 151 has discovered the AP 131 to which the terminal apparatus 101 has been connected at least at the timing of starting the first setup processing.

In step S403, the CPU 103 issues an AP search instruction to the communication apparatus 151 without designating the AP 131. More specifically, the CPU 103 transmits an AP search instruction for causing the communication apparatus 151 to execute search processing of searching for the AP outside the communication apparatus 151, without designating the SSID of the AP 131 and the channel with respect to the communication apparatus 151. Thus, the communication apparatus 151 acquires information of all APs in all channels that the communication apparatus 151 can detect.

Due to the memory capacity of the communication apparatus 151, the CPU 103 may issue the AP search instruction while setting an upper limit on the number of pieces of information of APs detected by the communication apparatus 151. Note that the upper limit on the number of pieces of information of APs detected by the communication apparatus 151 when executing the AP search processing may be set as the main body setting of the communication apparatus 151. With this, for example, the communication apparatus 151 starts to acquire the information of the AP which the communication apparatus 151 can detect, and finishes acquiring the information of AP when the upper limit on the number of pieces of information of APs is reached.

In step S404, the CPU 103 receives an AP search result from the communication apparatus 151. That is, the CPU 103 acquires the information of each AP discovered by the communication apparatus 151 from the communication apparatus 151.

In step S405, the CPU 103 determines whether the AP having the same SSID as the AP 131 having connected to the terminal apparatus 101 is included in the AP list. If it is determined that the AP having the same SSID as the AP 131 is included, the CPU 103 advances to step S406. On the other hand, if it is determined that the AP having the same SSID as the AP 131 is not included, the CPU 103 advances to step S407.

In step S406, the CPU 103 issues a wireless connection instruction for causing the communication apparatus 151 to wirelessly connect to the AP 131 by using the password of the AP 131 acquired in step S302. In other words, the wireless connection instruction is an instruction for causing the communication apparatus 151 to execute the wireless connection processing (to be described later) for connecting to the network formed by the AP 131. That is, when the wireless connection instruction is issued, based on the SSID and channel indicated by the connection reservation instruction, the communication apparatus 151 connects to the network formed by the AP 131 corresponding to the information indicated by the connection reservation instruction. In this embodiment, in step S401, the CPU 103 has already transmitted the SSID of the AP 131 and the information indicating the authentication method to the communication apparatus 151 as the connection information used when the communication apparatus 151 connects to the AP 131. Therefore, the CPU 103 need not transmit the SSID of the AP 131 and the information indicating the authentication method to the communication apparatus 151 again. Hence, in step S406, the CPU 103 transmits the password of the AP 131 and a wireless connection instruction to the communication apparatus 151. Note that if it is determined in step S405 that an AP having the same SSID as the AP 131 is included in the AP list, there may be a mesh environment where the passwords of the APs are set to the same password. Accordingly, if YES is determined in step S405, the CPU 103 transmits the password of the AP 131 and a wireless connection instruction in step S406. With the processing in step S406, the CPU 103 can cause the communication apparatus 151 to wirelessly connect to the AP 131 without prompting the user to input the password of the AP 131. After the processing in step S406 ends, the processing of this flowchart ends.

In step S407, the CPU 103 displays, on the display unit 108, an input screen (acceptance screen) that can accept a user input of information about the AP, which is to be transmitted to the communication apparatus 151. Here, for example, a screen as shown in FIG. 9A is displayed as an input screen 900 for accepting a user selection of the AP to be connected to the communication apparatus 151. The input screen 900 includes a region 902 for accepting an AP selection from the user, a region 903 for accepting an input of the password for connecting to the AP selected by the user, a region 904 indicating the authentication method used by the AP selected by the user, and a button 901 for specifying the AP corresponding to the input information as the AP to be connected to the communication apparatus 151. When the region 902 is selected, the AP search results acquired in step S404 are displayed as a list in a drop-down format. Note that if the OS of the terminal apparatus 101 already holds, as the wireless profile, the password used to connect to the AP selected by the user, the CPU 103 may not accept an input of the password from the user. If the AP selected by the user is not set with the authentication method and no password is required to connect to the AP, the CPU 103 may not accept an input of the password from the user. Instead of accepting the AP selected from the AP information list acquired in step S404, the CPU 103 may accept an input of an arbitrary SSID or password from the user, thereby specifying the AP corresponding to the input information as the AP to be connected to the communication apparatus 151. When the button 901 is selected, the CPU 103 saves the information selected or input on the input screen 900 as the setting information in order to transmit the setting information. Note that at this time, the CPU 103 may perform processing of verifying whether the information selected or input on the input screen 900 is correct. More specifically, the CPU 103 may verify whether the input password matches the format of the authentication method used by the selected AP.

In step S408, the CPU 103 transmits, to the communication apparatus 151, the setting information concerning the AP specified as the AP to be connected to the communication apparatus 151. The CPU 103 also transmits, to the communication apparatus 151, a wireless connection instruction for causing the communication apparatus 151 to execute the connection processing for connecting to the network formed by the AP for which the user selection has been accepted on the input screen 900. Note that the setting information includes the connection information (SSID and password) for connecting to the AP specified as the AP to be connected to the communication apparatus 151. After the processing in step S408 ends, the processing of this flowchart ends.

Note that in this embodiment, the CPU 103 advances to step S403 if NO is determined in step S402, but the present disclosure is not limited to this. For example, if NO is determined in step S402, the CPU 103 may advance to step S407. As will be described later, in this embodiment, in a case where the communication apparatus 151 does not support the authentication method of the AP 131, if the AP having the same SSID as the AP 131 is included in the information of APs around the terminal apparatus 101, the connection reservation instruction is executed using the information of this AP. This allows wireless connection of the communication apparatus 151 without issuing the above-described AP search instruction without designating the SSID of the AP 131 and the channel to the communication apparatus 151 in step S403. Even this configuration can shorten the time required for the first setup processing, thereby improving user convenience.

FIG. 5 is a flowchart showing an example of the AP search instruction processing, which is executed by the terminal apparatus 101, for causing the communication apparatus 151 to search for the AP while designating the SSID of the AP and the channel of the AP. This flowchart is implemented when the CPU 103 reads out the program stored in the ROM 104 into the RAM 105 and executes it. Note that in this embodiment, the terminal apparatus 101 executes the processing using the setup application. This flowchart corresponds to step S401.

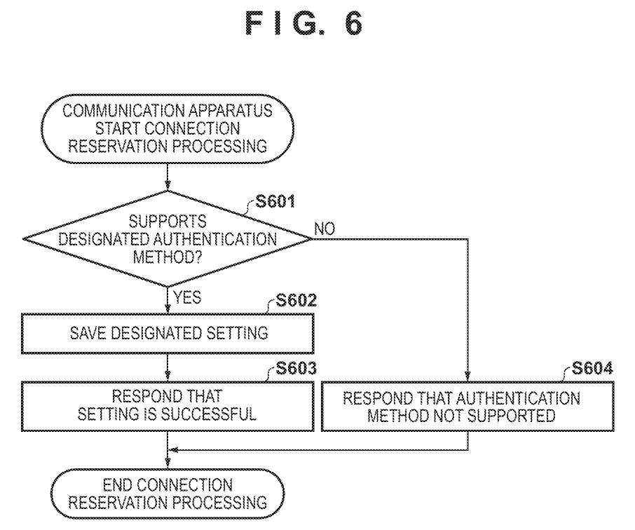

In step S501, the CPU 103 issues, to the communication apparatus 151, a connection reservation instruction designating the SSID of the AP 131 to which the terminal apparatus 101 has been connected at least at the timing of starting the first setup processing, and the authentication method. That is, in step S501, the CPU 103 transmits the SSID of the AP 131, information indicating the authentication method, and a connection reservation instruction to the communication apparatus 151. In other words, the connection reservation instruction is a hold instruction for causing the communication apparatus 151 to hold the information (the SSID and the information indicating the authentication method) of the AP if it supports the designated authentication method of the AP. With such the connection reservation instruction, the communication apparatus 151 holds the designated information of the AP if it supports the designated authentication method of the AP. The information of the AP 131 (the SSID of the AP 131 and the information indicating the authentication method) is used by the communication apparatus 151 when the CPU 103 issues a wireless connection instruction in step S406 as described above. Note that when the CPU 103 issues the connection reservation instruction, the communication apparatus 151 executes connection reservation processing to be described later. That is, it can also be said that the connection reservation instruction is an instruction for causing the communication apparatus 151 to execute connection reservation processing. Details of the connection reservation processing by the communication apparatus 151 will be described later with reference to FIG. 6.

In step S502, the CPU 103 acquires the result of the connection reservation instruction from the communication apparatus 151. That is, in step S502, the CPU 103 receives the result of the connection reservation instruction from the communication apparatus 151. More specifically, as the result of the connection reservation instruction issued in step S501, the CPU 103 receives information indicating whether the communication apparatus 151 supports the designated authentication method.

In step S503, the CPU 103 determines whether the communication apparatus 151 supports the authentication method designated by the CPU 103 in the connection reservation instruction. In other words, the CPU 103 determines whether the communication apparatus 151 supports the authentication method used in the network formed by the AP 131. If it is determined that the communication apparatus 151 supports the authentication method, the CPU 103 advances to step S504. On the other hand, if it is determined that the communication apparatus 151 does not support the authentication method, the CPU 103 advances to step S507. In this embodiment, if the result of the connection reservation instruction received from the communication apparatus 151 in step S502 is information indicating that the connection reservation is completed, the CPU 103 determines that the communication apparatus 151 supports the authentication method. On the other hand, if the result of the connection reservation instruction received from the communication apparatus 151 in step S502 is information indicating that the communication apparatus 151 does not support the authentication method, the CPU 103 determines that the communication apparatus 151 does not support the authentication method.

Here, an example of the determination in step S503 will be described. As described above, in step S501, the CPU 103 designates the authentication method of the AP 131 when transmitting the connection reservation instruction. For example, if the authentication method of the AP 131 designated in step S501 is an authentication method complying with Wi-Fi Protected Access3 (WPA3) (to be referred to as the WPA3 authentication method hereinafter), NO is determined in step S503. The authentication method complying with WPA3 is, for example, a WPA3-SAE (Simultaneous Authentication of Equals) method or a WPA3-EAP (Extensible Authentication Protocol) method. WPA3 is a relatively new Wi-Fi security protocol, and some communication apparatuses 151 may not support the WPA3 authentication method. Therefore, when the CPU 103 issues the connection reservation instruction, if the CPU 103 designates the WPA3 authentication method as the authentication method of the AP 131, information indicating that the communication apparatus 151 does not support the WPA3 is returned from the communication apparatus 151. On the other hand, for example, if the authentication method of the AP 131 designated in step S501 is an authentication method complying with WPA or an authentication method complying with WPA2, the CPU 103 determines YES in step S503. WPA and WPA2 are Wi-Fi security protocols introduced before WPA3. Hence, the communication apparatus 151 may support these authentication methods. Note that in the following description, the authentication method complying with WPA and the authentication method complying with WPA2 may be referred to as a WPA authentication method and a WPA2 authentication method, respectively. The WPA authentication method and WPA2 authentication method are, for example, WPA-PSK (Pre-Shared Key), WPA2-PSK, and the like.

Note that in this embodiment, an example will be described in which the communication apparatus 151 supports the WPA authentication method and the WPA2 authentication method but does not support the WPA3 authentication method. However, the present disclosure is not limited to this. For example, the communication apparatus 151 may support all of the WPA, WPA2, and WPA3 authentication methods.

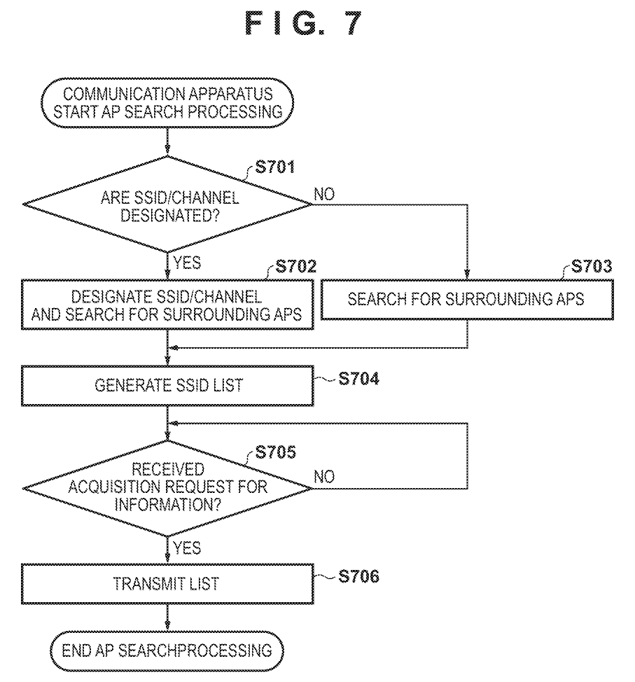

In step S504, the CPU 103 issues, to the communication apparatus 151, an AP search instruction to search for APs around the communication apparatus 151 while designating the SSID of the AP 131 and the channel. That is, the CPU 103 transmits, to the communication apparatus 151, an AP search instruction for causing the communication apparatus 151 to execute AP search processing of searching for the network formed by the AP 131. The AP 131 is the AP which is designated in the connection reservation instruction in step S501, and to which the terminal apparatus 101 has been connected at least at the timing of starting the first setup processing. With this search instruction, the communication apparatus 151 narrows down the SSID and the channel, and searches for nearby APs. By designating the SSID, the communication apparatus 151 can search for the AP set in SSID stealth setting. Details of the AP search processing by the communication apparatus 151 will be described later with reference to FIG. 7. Note that the CPU 103 transmits the AP search instruction via the connection between the terminal apparatus 101 and the communication apparatus 151 established in step S303.

In this manner, in this embodiment, based on that the communication apparatus 151 supports the authentication method used in the network formed by the AP 131 (YES in step S503), the CPU 103 controls to transmit the search instruction for the AP 131 in step S504. On the other hand, based on that the communication apparatus 151 does not support the authentication method used in the network formed by the AP 131 (NO in step S503), the CPU 103 advances to step S507 so that it controls not to transmit the search instruction for the AP 131. Thus, if the communication apparatus 151 does not support the authentication method of the AP 131, the communication apparatus 151 does not execute AP search processing for the AP 131. Hence, the setup time can be shortened.

In step S505, as the result of the search instruction for APs around the communication apparatus 151 executed in step S504, the CPU 103 acquires an AP information list. That is, the CPU 103 receives an AP information list from the communication apparatus 151. As described above, the AP information list includes information of the AP discovered around the communication apparatus 151. Therefore, as a result of issuing the AP search instruction in step S504, if the communication apparatus 151 has discovered the AP 131, the AP information list includes the information of the AP 131. On the other hand, if the communication apparatus 151 has not discovered the AP 131, the AP information list does not include the information of the AP 131. That is, in other words, step S505 is processing of, after transmitting the AP search instruction to the communication apparatus 151 in step S504, acquiring information indicating whether the communication apparatus 151 has discovered the network formed by the AP 131 from the communication apparatus.

In step S506, the CPU 103 determines whether the information of the AP 131 is included in the AP information list acquired in step S505. If it is determined that the information of the AP 131 is included, the CPU 103 terminates the processing of this flowchart. On the other hand, if it is determined that the information of the AP 131 is not included, the CPU 103 advances to step S507.

In this manner, in this embodiment, the CPU 103 designates the AP 131 in step S504, and issues the AP search instruction for the AP 131. Then, the CPU 103 acquires the information of nearby APs from the communication apparatus 151, and determines in step S506 whether the AP 131 has been discovered. If it is determined that the AP has not been discovered (NO in step S506), the CPU 103 advances to step S507. Thus, if the communication apparatus 151 cannot find the AP 131 designated in the connection reservation instruction, it is possible to try the connection reservation instruction for another AP, as will be described later.

In step S507, the CPU 103 detects, from the APs around the terminal apparatus 101, the AP having the same SSID as the AP 131 specified in step S302. That is, the CPU 103 executes processing for narrowing down the AP having the same SSID as the AP 131 from the APs around the terminal apparatus 101. As described above, when the CPU 103 searches for APs around (APs outside) the terminal apparatus 101 in step S301, the information (such as the SSID) of the discovered AP is held as the AP information list in the memory such as the RAM 105. In step S507, the CPU 103 acquires the AP information list held in the memory in step S301. Then, the CPU 103 acquires the SSID of the AP 131 specified in step S302 from the AP information list. Note that in step S507, the CPU 103 may search for APs around the terminal apparatus 101 and detect the AP having the same SSID as the AP 131.

In step S507, if the AP that uses the same authentication method as the authentication method designated in the connection reservation instruction issued in step S501 is included in the AP information, the CPU 103 may omit this AP. More specifically, if the authentication method of the AP 131 designated in the connection reservation instruction issued in step S501 is the WPA3 authentication method, the CPU 103 may omit the AP that uses the WPA3 authentication method from the APs narrowed down in step S507. This is because, when the authentication method is the same as that of the AP 131, even if a connection reservation instruction is issued, the communication information 151 returns information indicating that it does not support the authentication method.

In step S508, the CPU 103 determines whether the information of the AP having the same SSID as the AP 131 is discovered in the AP information list as a result of step S507. In other words, the CPU 103 determines whether the AP that forms a network set with the same network name (SSID) as the network formed by the AP 131 is included in the AP information list. If it is determined that the information of the AP is discovered, the CPU 103 advances to step S509. On the other hand, if it is determined that the information of the AP is not discovered, the CPU 103 terminates the processing of this flowchart.

In step S509, the CPU 103 issues a connection reservation instruction designating the SSID of the AP having the same SSID as the AP 131 detected in step S507, and the authentication method. That is, in step S509, the CPU 103 transmits the SSID of the AP narrowed down in step S507, information indicating the authentication method, and a connection reservation instruction to the communication apparatus 151.

In step S510, the CPU 103 acquires the result of the connection reservation instruction. That is, in step S510, the CPU 103 receives the result of the connection reservation instruction from the communication apparatus 151. More specifically, as the result of the connection reservation instruction issued in step S509 information indicating whether the communication apparatus 151 supports the authentication method designated by the CPU 103 is acquired.

In step S511, the CPU 103 determines whether the communication apparatus 151 supports the authentication method designated by the CPU 103 in the connection reservation instruction. If it is determined that the authentication method is supported, the CPU 103 advances to step S512. On the other hand, if it is determined that the authentication method is not supported, the CPU 103 advances to step S515. More specifically, if the information received from the communication apparatus 151 in step S510 is information indicating that the authentication method is supported, the CPU 103 advances to step S512; otherwise, the CPU 103 advances to step S515.

In step S512, the CPU 103 issues, to the communication apparatus 151, an AP search instruction to search for APs around the communication apparatus 151 while designating the SSID of the AP 131 and the channel. That is, the CPU 103 transmits, to the communication apparatus 151, an AP search instruction for causing the communication apparatus 151 to execute AP search processing of searching for the AP having the same SSID as the network formed by the AP 131. With this instruction, the communication apparatus 151 narrows down the SSID and the channel, and searches for nearby APs. By designating the SSID, the communication apparatus 151 can search for the AP set in SSID stealth setting. Details of the AP search processing by the communication apparatus 151 will be described later with reference to FIG. 7.

In step S513, as the result of the search instruction for APs around the communication apparatus 151 executed in step S512, the CPU 103 acquires an AP information list. That is, the CPU 103 receives an AP information list from the communication apparatus 151.

In step S514, the CPU 103 determines whether the AP having the same SSID as the AP 131 is included in the AP information list acquired in step S513. If it is determined that the AP is included, the CPU 103 terminates the processing of this flowchart. On the other hand, if it is determined that the AP is not included, the CPU 103 advances to step S515.

In step S515, the CPU 103 determines whether the AP information list narrowed down in step S507 includes the information of an AP for which a connection reservation instruction has not been executed. If it is determined that the information of such an AP is included, the CPU 103 returns to step S509. On the other hand, if it is determined that the information of such an AP is not included, the CPU 103 terminates the processing of this flowchart.

Note that in this embodiment, if it is determined in step S503 that the communication apparatus 151 does not support the authentication method (NO in step S503), the CPU 103 advances to step S507. However the present disclosure is not limited to this. For example, if NO is determined in step S503, the CPU 103 may terminate this flowchart. Note that if NO is determined in step S503 and the flowchart is terminated, the CPU 103 determines that the AP information is not included in step S402 described above.

In this embodiment, the CPU 103 advances to step S506 after step S505, but the present disclosure is not limited to this. For example, the CPU 103 may terminate this flowchart without executing the processing in step S506 after step S505.

In this embodiment, if it is determined in step S511 that the authentication method is supported (YES in step S511), the CPU 103 advances to step S512. However, the present disclosure is not limited to this. If YES is determined in step S511, the CPU 103 may return to step S504. Note that if YES is determined in step S511, in step S504, the CPU 103 designates the SSID of the AP and the channel designated in the connection reservation instruction issued in step S509.

FIG. 6 is a flowchart showing an example of the connection reservation processing executed by the communication apparatus 151. This flowchart is implemented when the CPU 154 reads out the program stored in the ROM 152 into the RAM 153 and executes it. This flowchart is started based on that the communication apparatus 151 accepts, from the terminal apparatus 101, a connection reservation instruction including the SSID and information indicating the authentication method.

In step S601, the CPU 154 determines whether the communication apparatus 151 supports the authentication method received from the terminal apparatus 101. For example, if the authentication method designated by the terminal apparatus 101 is the WPA3 authentication method, the CPU 154 determines whether the communication apparatus 151 supports the WPA3 authentication method. If it is determined that the communication apparatus 151 supports the designated authentication method, the CPU 154 advances to step S602. On the other hand, if it is determined that the communication apparatus 151 does not support the designated authentication method, the CPU 154 advances to step S604.

In step S602, the CPU 154 saves, in the RAM 153, the information of the AP (such as the SSID of the AP, the information indicating the authentication method of the AP, and the password corresponding to the SSID) designated by the terminal apparatus 101.

In step S603, as information indicating that the communication apparatus 151 supports the authentication method designated by the terminal apparatus 101, the CPU 154 transmits, to the terminal apparatus 101, information indicating that the information of the AP has been saved. After the processing in step S603 ends, the processing of this flowchart ends.

In step S604, the CPU 154 transmits information indicating that the communication apparatus 151 does not support the authentication method designated by the terminal apparatus 101. After the processing in step S604 ends, the processing of this flowchart ends.

FIG. 7 is a flowchart showing an example of the AP search processing executed by the communication apparatus 151. This flowchart is implemented when the CPU 154 reads out the program stored in the ROM 152 into the RAM 153 and executes it. This flowchart is started based on that the communication apparatus 151 accepts an AP search instruction including the SSID and the channel from the terminal apparatus 101. This flowchart is also started based on that the communication apparatus 151 accepts an AP search instruction not designating the SSID and the channel.

In step S701, the CPU 154 determines whether the instruction accepted from the terminal apparatus 101 is an AP search instruction including the SSID and the channel. If it is determined that the AP search instruction includes the SSID and the channel, the CPU 154 advances to step S702. On the other hand, if it is determined that the AP search instruction does not include the SSID and the channel, the CPU 154 advances to step S703.

In step S702, the CPU 154 searches for APs around the communication apparatus 151 while designating the SSID and the channel. More specifically, the CPU 154 searches for beacons generated by APs around the communication apparatus 151 while designating the SSID and the channel.

In step S703, the CPU 154 searches for APs around the communication apparatus 151. More specifically, the CPU 154 searches for beacons generated by APs around the communication apparatus 151 without designating the SSID.

In step S704, the CPU 154 generates a list of the information of the APs around the communication apparatus 151, which have been discovered in step S702 or step S703. That is, in step S704, the CPU 154 generates an AP information list for the APs discovered around the communication apparatus 151.

In step S705, the CPU 154 determines whether an acquisition request for the AP information list generated in step S704 is received from the terminal apparatus 101. If it is determined that an acquisition request is received, the CPU 154 advances to step S706. On the other hand, if it is determined that an acquisition request for the AP information list is not received, the CPU 154 repeats the processing in step S705.

In step S706, the CPU 154 transmits the AP information list generated in step S704 to the terminal apparatus 101. After the processing in step S706 ends, the processing of this flowchart ends.

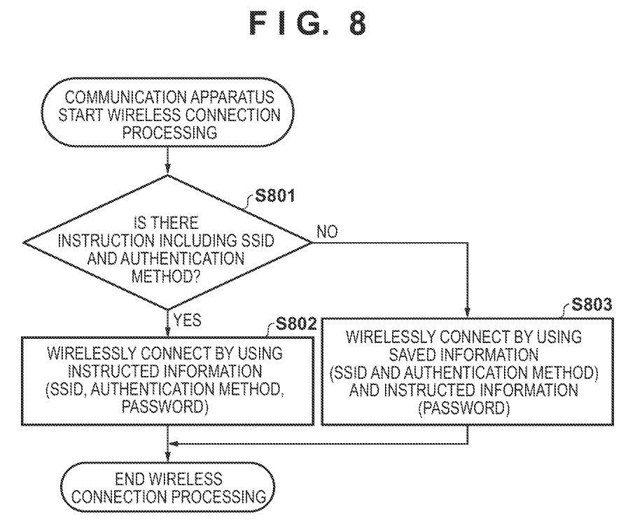

FIG. 8 is a flowchart showing an example of the wireless connection processing executed by the communication apparatus 151. This flowchart is implemented when the CPU 154 reads out the program stored in the ROM 152 into the RAM 153 and executes it. This flowchart is started based on that the communication apparatus 151 accepts, from the terminal apparatus 101, a wireless connection instruction including the SSID, the information indicating the authentication method, and the password of the SSID. This flowchart is also started based on that the communication apparatus 151 accepts a wireless connection instruction including the password from the terminal apparatus 101.

In step S801, the CPU 154 determines whether the instruction accepted from the terminal apparatus 101 is a wireless connection instruction including the SSID and the information indicating the authentication method. If it is determined that the instruction is a wireless connection instruction including the SSID and the information indicating the authentication method, the CPU 154 advances to step S802. On the other hand, if it is determined that the instruction is a wireless connection instruction not including the SSID and the information indicating the authentication method, the CPU 154 advances to step S803.

In step S802, the CPU 154 wirelessly connects to the designated AP by using the SSID, the information indicating the authentication method, and the password accepted from the terminal apparatus 101. After the processing in step S802 is completed, the processing of this flowchart ends.

In step S803, the CPU 154 wirelessly connects to the AP by using the password accepted from the terminal apparatus 101, and the SSID and authentication method saved in the RAM 153 in step S602. After the processing in step S803 ends, the processing of this flowchart ends.

According to this embodiment, the setup application causes the CPU 103 of the terminal apparatus 101 to operate as follows. In the first setup processing, if the communication apparatus 151 does not support the authentication method of the designated AP 131, the CPU 103 does not issue the AP search instruction designating the SSID and the channel to the communication apparatus 151. This operation can omit the search processing of searching for the AP not supported by the communication apparatus 151 in the first setup processing. As a result, the setup time of the communication apparatus 151 can be shortened.

### Second Embodiment

In this embodiment, a CPU 103 designates the SSID and authentication method of an AP 131 and, when issuing a connection reservation instruction, also designates the password corresponding to the SSID with respect to a communication apparatus 151. With this, in a case where the communication apparatus 151 supports the authentication method of the AP 131, the CPU 103 can execute a wireless connection instruction if an AP having the SSID and authentication method designated in the connection reservation instruction is detected through a search instruction for nearby APs. This can shorten the setup time, and improve user convenience.

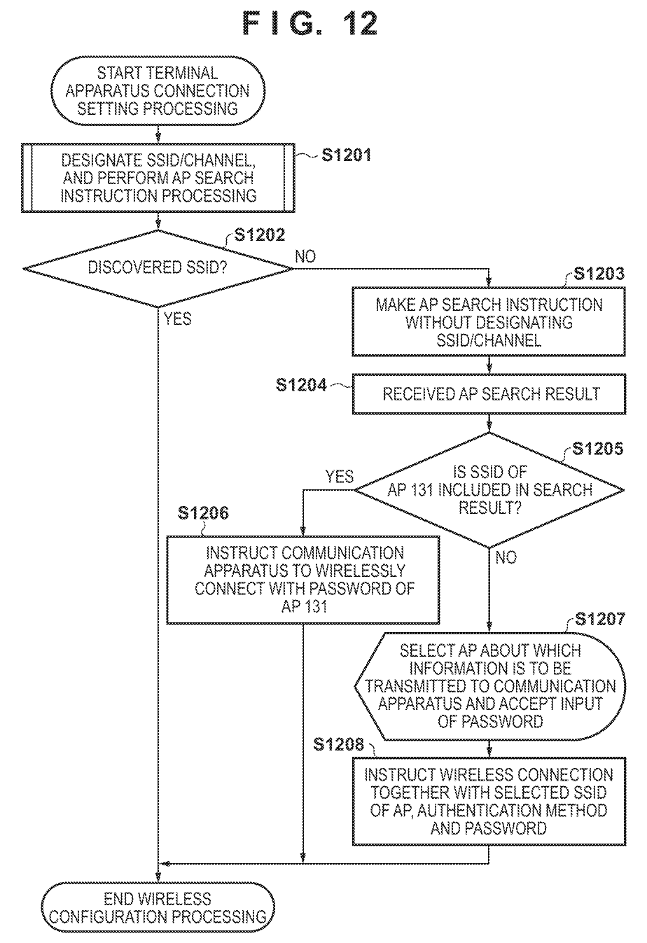

FIG. 12 is a flowchart showing an example of the first setup processing of the communication apparatus 151, which is executed by a terminal apparatus 101, according to this embodiment. This flowchart is implemented when the CPU 103 reads out the program stored in a ROM 104 into a RAM 105 and executes it. Note that in this embodiment, the terminal apparatus 101 executes the processing using a setup application. This flowchart corresponds to step S304.

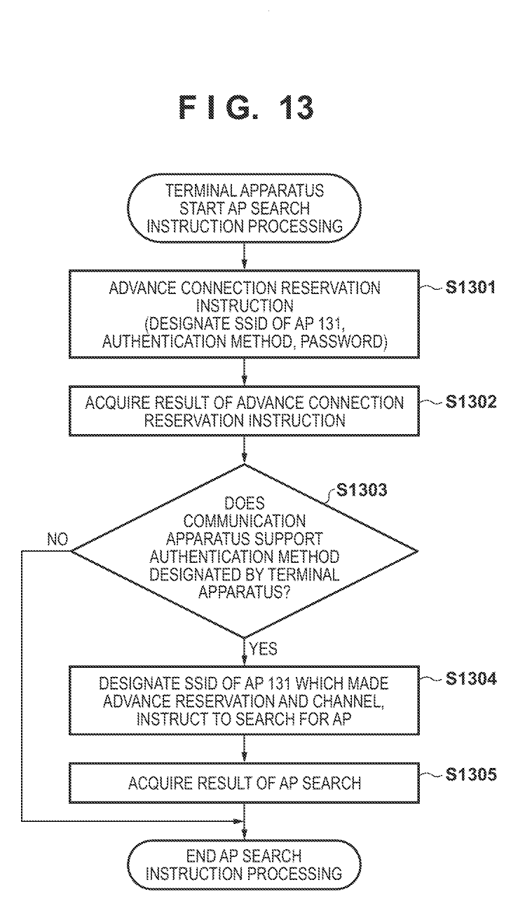

In step S1201, the CPU 103 designates the SSID of the AP and the channel, and executes AP search instruction processing for causing the communication apparatus 151 to search for the AP. In this embodiment, as will be described later, in the AP search instruction processing, the CPU 103 first issues a connection reservation instruction designating the SSID of the AP 131, the channel, and the password to the communication apparatus 151. The CPU 103 then determines whether the communication apparatus 151 supports the authentication method of the AP 131. The CPU 103 receives the result of the connection reservation instruction from the communication apparatus 151, and determines whether the communication apparatus 151 supports the authentication method of the AP 131. If the communication apparatus 151 supports the authentication method of the AP 131, the CPU 103 issues a search instruction for the AP 131 to the communication apparatus 151. Details of step S1201 will be described later with reference to FIG. 13.

In step S1202, the CPU 103 determines whether the information of the AP 131 is included in the AP information list as the result of the AP search instruction processing in step S1201. If it is determined that the information of the AP 131 is included, the processing of this flowchart ends. If it is determined that the information of the AP 131 is not included, the CPU 103 advances to step S1203. In the connection setting processing according to the first embodiment, the CPU 103 issues a wireless connection instruction to the communication apparatus 151 together with the password of the AP 131 in step S406. In this embodiment, as described above, the CPU 103 has already transmitted the password of the AP 131 together with the connection reservation instruction in the AP search instruction processing in step S1201. Hence, in this embodiment, if NO in step S1202, this flowchart is terminated.

Steps S1203 to S1208 are similar to steps S403 to S408 of FIG. 4, so that a description thereof will be omitted.

FIG. 13 is a flowchart showing an example of the AP search instruction processing executed by the terminal apparatus 101 according to this embodiment. This flowchart is implemented when the CPU 103 reads out the program stored in the ROM 104 into the RAM 105 and executes it. Note that in this embodiment, the terminal apparatus 101 executes the processing using the setup application. This flowchart corresponds to step S1201.

In step S1301, the CPU 103 designates the SSID of the AP 131, the authentication method, and the password, and executes a connection reservation instruction with respect to the communication apparatus 151. That is, in step S1301, the CPU 103 transmits the SSID of the AP 131, information indicating the authentication method, the password, and a connection reservation instruction to the communication apparatus 151. As each information, the information acquired by the CPU 103 in step S302 is used. In the first embodiment, in the AP search instruction processing, the CPU 103 designates the SSID of the AP 131 and the authentication method in step S510. In this embodiment, the CPU 103 also designates the password of the AP 131 in the connection reservation instruction in step S1301.

Step S1302 is similar to step S502 of FIG. 5, and a description thereof will be omitted.

In step S1303, the CPU 103 determines whether the communication apparatus 151 supports the authentication method designated by the CPU 103 in the connection reservation instruction. If it is determined that the communication apparatus 151 supports the authentication method, the CPU 103 advances to step S1304. On the other hand, if it is determined that the communication apparatus 151 does not support the authentication method, the CPU 103 terminates this flowchart.

Steps S1304 and S1305 are similar to steps S504 and S505 of FIG. 5, so that a description thereof will be omitted.

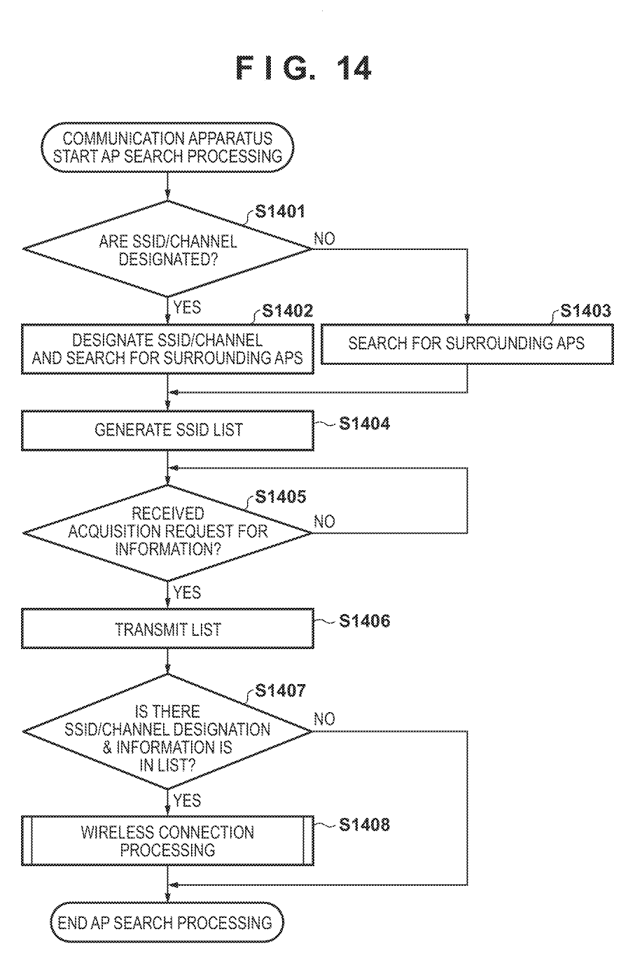

FIG. 14 is a flowchart showing an example of the AP search processing executed by the communication apparatus 151 according to this embodiment. This flowchart is implemented when a CPU 154 reads out the program stored in a ROM 152 into a RAM 153 and executes it. This flowchart is started based on that the communication apparatus 151 accepts an AP search instruction including the SSID and the channel from the terminal apparatus 101. This flowchart is also started based on that the communication apparatus 151 accepts an AP search instruction not designating the SSID and the channel.

Steps S1401 to S1406 are similar to steps S701 to S706 of FIG. 7, so that a description thereof will be omitted.

In step S1407, the CPU 154 determines whether the information of the AP 131 designated by the terminal apparatus 101 is included in the AP information list transmitted to the terminal apparatus 101. If it is determined that the information of the AP 131 is included in the AP information list, the CPU 154 advances to step S1408. On the other hand, if it is determined that the information of the AP 131 is not included in the AP information list, the CPU 154 terminates the processing of this flowchart.

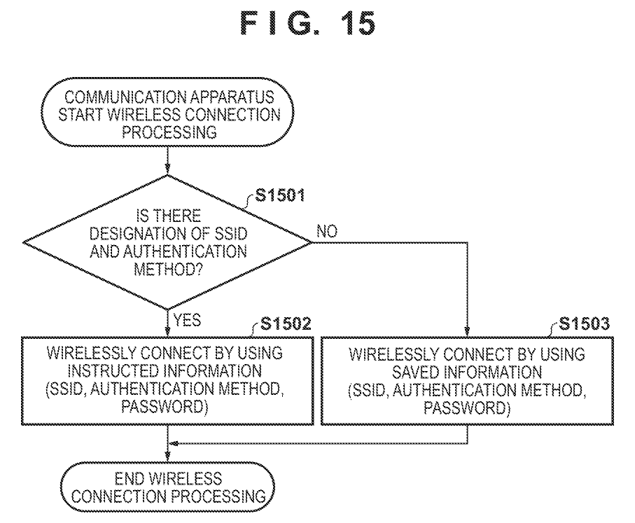

In step S1408, the CPU 154 executes wireless connection processing using the SSID of the AP 131, the authentication method, and the password, which are designated by the terminal apparatus 101. Details of step S1408 will be described later with reference to FIG. 15. After the processing in step S1408 ends, the processing of this flowchart ends.

FIG. 15 is a flowchart showing an example of the wireless connection processing of the communication apparatus 151 according to this embodiment. This flowchart is implemented when the CPU 154 reads out the program stored in the ROM 152 into the RAM 153 and executes it. This flowchart corresponds to step S1408.

Steps S1501 and S1502 are similar to steps S801 and S802 of FIG. 8, so that a description thereof will be omitted.

In step S1503, the CPU 154 executes wireless connection using the SSID of the AP 131, the information indicating the authentication method, and the password, which are saved in the RAM 153. After step S1503 ends, the processing of this flowchart ends.

According to this embodiment, the setup application causes the CPU 103 of the terminal apparatus 101 to operate as follows. In the AP search instruction processing, the CPU 103 issues a connection reservation instruction designating the SSID of the AP 131, the authentication method, and the password corresponding to the SSID. If the communication apparatus 151 supports the designated authentication method of the AP 131, it searches for the AP 131 when a search instruction for the AP 131 is received from the terminal apparatus 101. If the AP 131 is discovered, the communication apparatus 151 transmits an AP information list including the information of the AP 131 to the communication apparatus 151. After that, the communication apparatus 151 wirelessly connects to the AP 131 by using the password of the AP 131 received from the terminal apparatus 101 together with the connection reservation instruction. In this manner, the CPU 103 transmits, to the communication apparatus 151, the password of the AP 131 in advance together with the connection reservation instruction. This can omit the processing of issuing a wireless connection instruction in a case where the communication apparatus 151 supports the authentication method of the AP 131. As a result, the setup time can be further shortened.

### Third Embodiment

In this embodiment, a CPU 103 acquires capability information from a communication apparatus 151. Capability information is various kinds of setting information of the communication apparatus 151, and includes, for example, the authentication method support information of the communication apparatus 151 and the like. The CPU 103 uses the acquired capability information to determine whether the communication apparatus 151 supports the authentication method of an AP 131 connected to a terminal apparatus 101. By using the capability information of the communication apparatus 151, for example, even if the communication apparatus 151 does not support connection reservation processing, it is possible to determine the authentication method supported by the communication apparatus 151. In addition, even if the authentication method of the AP 131 to which the terminal apparatus 101 has been connected at least at the timing of starting the first setup processing cannot be acquired, it is possible to determine the authentication method supported by the communication apparatus 151.

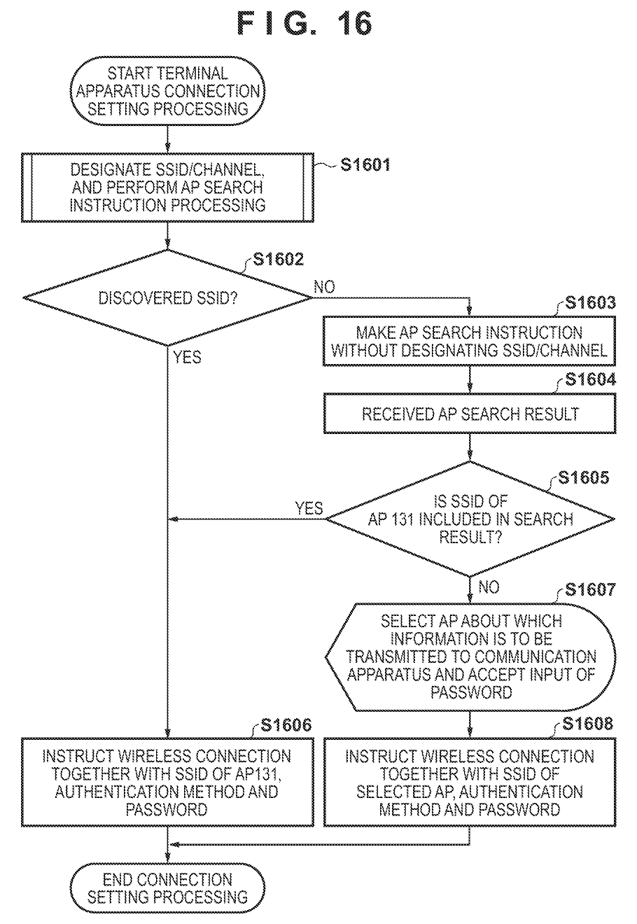

FIG. 16 is a flowchart showing an example of the first setup processing of the communication apparatus 151, which is executed by the terminal apparatus 101, according to this embodiment. This flowchart is implemented when the CPU 103 reads out the program stored in a ROM 104 into a RAM 105 and executes it. Note that in this embodiment, the terminal apparatus 101 executes the processing using a setup application. This flowchart corresponds to step S304.

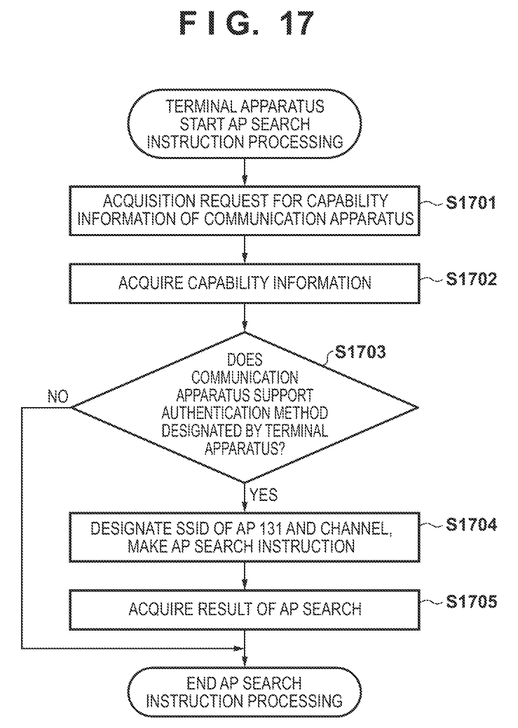

In step S1601, the CPU 103 executes AP search instruction processing for causing the communication apparatus 151 to search for the AP. In the embodiment described above, in the AP search instruction processing, the CPU 103 first issues a connection reservation instruction designating the AP 131 to the communication apparatus 151. Based on the result of the connection reservation instruction, the CPU 103 determines whether the communication apparatus 151 supports the authentication method of the AP 131. In this embodiment, as will be described later, in the AP search instruction processing, the CPU 103 acquires the capability information of the communication apparatus 151. Based on the capability information, the CPU 103 determines whether the communication apparatus 151 supports the authentication method of the AP 131. Details of step S1601 will be described later with reference to FIG. 17.

In step S1602, the CPU 103 determines whether the information of the AP 131 is included in the AP information list as the result of the AP search instruction processing in step S1601. If it is determined that the information of the AP 131 is included, the CPU 103 advances to step S1606. On the other hand, if it is determined that the information of the AP 131 is not included, the CPU 103 advances to step S1603.

Steps S1603 and S1604 are similar to steps S403 and S404, so that a description thereof will be omitted.

In step S1605, the CPU 103 determines whether the AP having the same SSID as the AP 131 having connected to the terminal apparatus 101 is included in the AP list. If it is determined that the AP having the same SSID as the AP 131 is included, the CPU 103 advances to step S1606. On the other hand, if it is determined that the AP having the same SSID as the AP 131 is not included, the CPU 103 advances to step S1607.

In step S1606, the CPU 103 issues, to the communication apparatus 151, a wireless connection instruction including the SSID of the AP 131 connected to the terminal apparatus 101, information indicating the authentication method, and the password. Since connection reservation processing is not performed in this embodiment, these pieces of information are transmitted together with the wireless connection instruction. Note that the SSID and information indicating the authentication method are transmitted with the wireless connection instruction, but connection reservation may be performed only for the SSID. Alternatively, in step S1606, the wireless connection instruction including the password corresponding to the SSID may be issued, and the authentication method for connection may be decided from the AP information acquired when the communication apparatus 151 acquires nearby AP information.

Steps S1607 and S1608 are similar to steps S407 and S408, so that a description thereof will be omitted.

FIG. 17 is a flowchart showing an example of the nearby AP search instruction processing designating AP information of the communication apparatus 151, which is executed by the terminal apparatus 101, according to this embodiment. This flowchart is implemented when the CPU 103 reads out the program stored in the ROM 104 into the RAM 105 and executes it. Note that in this embodiment, the terminal apparatus 101 executes the processing using the setup application. This flowchart corresponds to step S1601.

In step S1701, the CPU 103 transmits an acquisition request for the capability information of the communication apparatus 151 to the communication apparatus 151. The capability information to be acquired by the CPU 103 in step S1701 includes information indicating the authentication method supported by the communication apparatus 151, as described above.

In step S1702, the CPU 103 receives the capability information from the communication apparatus 151, thereby acquiring the capability information of the communication apparatus 151. In addition, in step S1702, the CPU 103 extracts the information indicating the authentication method supported by the communication apparatus 151 from the acquired capability information.

In step S1703, the CPU 103 determines whether the communication apparatus 151 supports the authentication method of the AP 131. If it is determined that the communication apparatus 151 supports the authentication method, the CPU 103 advances to step S1704. On the other hand, if it is determined that the communication apparatus 151 does not support the authentication method, the CPU 103 terminates the processing of FIG. 17. In this embodiment, the CPU 103 performs this determination based on the information indicating the authentication method supported by the communication apparatus 151, which is included in the capability information received from the communication apparatus 151 in step S1702.

In step S1704, the CPU 103 issues an AP search instruction to search for APs around the communication apparatus 151 while designating the SSID of the AP 131 and the channel. That is, the CPU 103 transmits, to the communication apparatus 151, an AP search instruction to search for the AP 131 which is the AP to which the terminal apparatus 101 has been connected at least at the timing of starting the first setup processing.

In step S1705, as the result of the search instruction for APs around the communication apparatus 151 executed in step S1704, the CPU 103 acquires an AP information list. That is, the CPU 103 receives an AP information list from the communication apparatus 151.

According to this embodiment, the setup application causes the CPU 103 of the terminal apparatus 101 to operate as follows. The CPU 103 acquires capability information from the communication apparatus 151. Then, based on the capability information, the CPU 103 determines whether the communication apparatus 151 supports the authentication method of the AP 131 connected to the terminal apparatus 101. If it is determined that the communication apparatus 151 supports the authentication method of the AP 131, the CPU 103 issues a search instruction for the AP 131 to the communication apparatus 151. On the other hand, if it is determined that the communication apparatus 151 does not support the authentication method of the AP 131, the CPU 103 does not issue a search instruction for the AP 131 to the communication apparatus 151. That is, in this embodiment, the CPU 103 controls whether to transmit a search instruction for the AP 131 based on the capability information acquired from the communication apparatus 151. With this, even if the communication apparatus 151 does not support connection reservation processing, or even if information indicating the authentication method used for connection is not acquired from the terminal apparatus 101, it is possible to determine whether the communication apparatus 151 supports the authentication method of the AP 131. This configuration makes it possible to check whether the communication apparatus 151 supports the authentication method of the AP 131 regardless of the environment of the terminal apparatus 101 or the communication apparatus 151. Accordingly, user convenience can be further improved.

### Fourth Embodiment

In this embodiment, a CPU 103 designates the SSID of an AP 131 and the channel with respect to a communication apparatus 151, and issues a search instruction for the AP 131. If the communication apparatus 151 supports the authentication method of the AP 131, it saves the information such as the SSID of the AP 131 designated by a terminal apparatus 101. With this configuration, the terminal apparatus 101 can cause the communication apparatus 151 to save the information in advance only by transmitting an AP search instruction to the communication apparatus 151 without transmitting a connection reservation instruction. Hence, the setup time can be shortened, and user convenience can be improved.

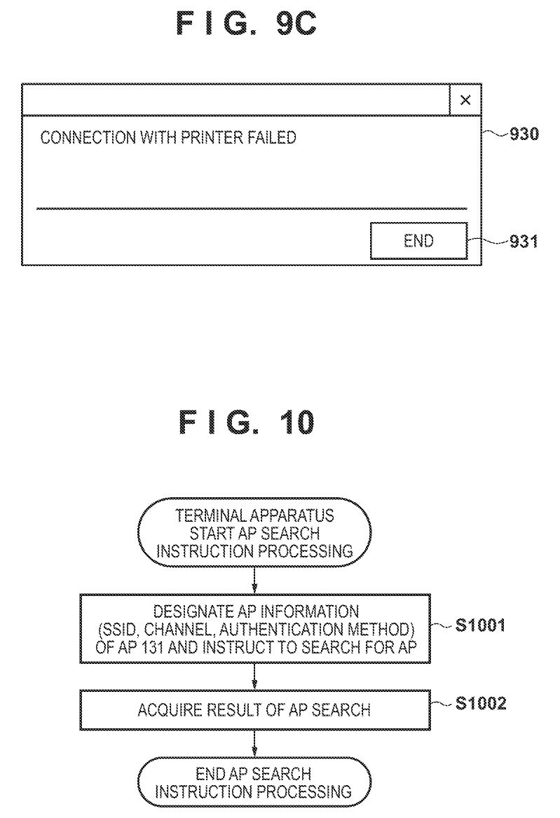

FIG. 10 is a flowchart showing an example of the nearby AP search instruction processing designating AP information of the communication apparatus 151, which is executed by the terminal apparatus 101, according to this embodiment. This flowchart is implemented when the CPU 103 reads out the program stored in a ROM 104 into a RAM 105 and executes it. Note that in this embodiment, the terminal apparatus 101 executes the processing using a setup application. This flowchart corresponds to step S401.

In step S1001, the CPU 103 transmits, to the communication apparatus 151, a search instruction for the AP 131 while designating the SSID of the AP 131 to which the terminal apparatus 101 has been connected at least at the timing of starting the first setup processing, the channel, and the authentication method. In the first embodiment and the second embodiment, in the AP search instruction processing, the CPU 103 first issues a connection reservation instruction designating the AP 131. In this embodiment, in step S1001, the CPU 103 transmits, to the communication apparatus 151, the SSID of the AP 131, the channel, information indicating the authentication method, and a search instruction for the AP 131.

In step S1002, the CPU 103 acquires the result of the search instruction for the AP 131. That is, the CPU 103 receives the result of the search instruction for the AP 131. As will be described later, if the communication apparatus 151 supports the authentication method of the AP 131 designated in step S1001, an AP information list is received as the result of the search instruction for the AP 131. On the other hand, if the communication apparatus 151 does not support the authentication method designated in step S1001, information indicating that the communication apparatus 151 does not support the authentication method is received as the result of the AP search instruction. After the processing in step S1002 ends, the processing of this flowchart ends.

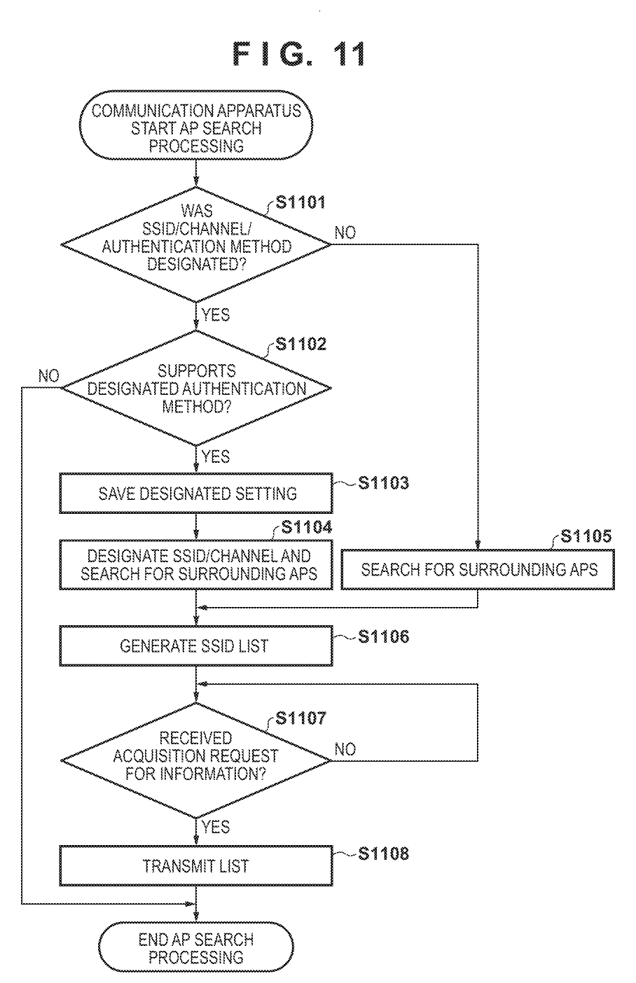

FIG. 11 is a flowchart illustrating the AP search processing of the communication apparatus 151 according to this embodiment. This flowchart is implemented when a CPU 154 reads out the program stored in a ROM 152 into a RAM 153 and executes it. This flowchart is started based on that the communication apparatus 151 accepts an AP search instruction including the SSID, the channel, and the authentication method from the terminal apparatus 101. This flowchart is also started based on that the communication apparatus 151 accepts an AP search instruction not designating the SSID, the channel, and the authentication method.

In step S1101, the CPU 154 determines whether the instruction accepted from the terminal apparatus 101 is an AP search instruction including the information (the SSID, the channel, and the information indicating the authentication method) of the AP. That is, it is determined whether the AP is designated by the terminal apparatus 101. If it is determined that the AP search instruction includes the information of the AP, the CPU 154 advances to step S1102. If it is determined that the AP search instruction does not include the information of the AP, the CPU 154 advances to step S1105.

In step S1102, the CPU 154 determines whether the communication apparatus 151 supports the authentication method designated by the terminal apparatus 101. If it is determined that the communication apparatus 151 supports the authentication method, the CPU 154 advances to step S1103. On the other hand, if it is determined that the communication apparatus 151 does not support the authentication method, the CPU 154 terminates the processing of this flowchart.

In step S1103, the CPU 154 saves, in the RAM 153, the information of the AP (the SSID of the AP, the channel, and the information indicating the authentication method of the AP) designated by the terminal apparatus 101. In the first embodiment and the second embodiment, the CPU 154 receives a connection reservation instruction from the terminal apparatus 101 and, if the communication apparatus 151 supports the authentication method of the AP designated in the connection reservation instruction, saves the designated information of the AP. In this embodiment, when the AP search instruction is received, if the communication apparatus 151 supports the authentication method of the AP targeted for the search, the CPU 154 saves the information of the AP targeted for the search.

Steps S1104 to S1108 are similar to steps S702 to S706 of FIG. 7, so that a description thereof will be omitted.

According to this embodiment, the setup application causes the CPU 103 of the terminal apparatus 101 to operate as follows. In the AP search instruction processing, the CPU 103 transmits, to the communication apparatus 151, a search instruction for the AP 131 while designating the AP 131. In this embodiment, the communication apparatus 151 receives, from the terminal apparatus 101, the AP search instruction designating the SSID of the AP 131, the channel, and the authentication method. If the communication apparatus 151 supports the designated authentication method of the AP 131, it saves the information such as the SSID of the AP 131. With this configuration, the CPU 103 can execute the connection setting processing only by transmitting an AP search instruction designating AP 131 to the communication apparatus without transmitting a connection reservation instruction in the AP search instruction processing. That is, the setup time can be shortened, and user convenience can be further improved.

According to the present disclosure, it is possible to provide a technique that improves convenience when an information processing apparatus causes a communication apparatus to connect to another apparatus.

It is needless to say that the present disclosure is achieved by supplying a storage medium which stores software program codes for implementing the functions of the above-described embodiment to a system or an apparatus, and the computer (CPU or MPU) of the system or the apparatus reading out and executing the programs codes stored in the storage medium. In this case, the program codes read out from the storage medium implement the functions of the above-described embodiment by themselves, and the storage medium which stores the program codes constitutes the embodiment.

As the storage medium for supplying the program codes, for example, a flexible disk, a hard disk, an optical disk, a magneto-optical disk, a CD-ROM, a CD-R, a magnetic tape, a nonvolatile memory card, a ROM, a DVD, or the like can be used.

It is also needless to say that the functions of the above-described embodiment are implemented not only when the readout program codes are executed by the computer but also when the operating system running on the computer performs a part or all of actual processing on the basis of the instructions of the program codes.

Furthermore, it is also needless to say that the program codes read out from the storage medium are written in the memory of a function extension board inserted into the computer or a function extension unit connected to the computer, and thereafter the CPU of the function extension board or function extension unit performs part or all of actual processing on the basis of the instructions of the program codes, and the functions of the above-described embodiment are implemented by this processing.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-176740, filed October 8, 2024 which is hereby incorporated by reference herein in its entirety.

What is claimed is:

1. A non-transitory computer-readable storage medium storing an application program configured to cause a computer of an information processing apparatus to function as:
a first acceptance unit configured to accept a connection setting instruction for performing connection setting of a communication apparatus; and
a first transmission unit configured to transmit, to the communication apparatus, a first search instruction for causing the communication apparatus to execute search processing of searching for a first network formed by a predetermined access point connected to the information processing apparatus at least at a timing of accepting the connection setting instruction,
wherein, based on that the communication apparatus does not support a predetermined authentication method used in the first network, it is controlled not to transmit the first search instruction to the communication apparatus, and based on that the communication apparatus supports the predetermined authentication method, it is controlled to transmit the first search instruction to the communication apparatus.

2. The medium according to claim 1, wherein
the computer is caused to further function as
a second transmission unit configured to, in a case where the connection setting instruction is accepted, transmit information indicating the predetermined authentication method to the communication apparatus, and
a first reception unit configured to, after the information indicating the predetermined authentication method is transmitted, receive information indicating whether the communication apparatus supports the predetermined authentication method from the communication apparatus, and
based on the information indicating whether the communication apparatus supports the predetermined authentication method and received by the first reception unit, it is controlled whether to transmit the first search instruction.

3. The medium according to claim 2, wherein
the second transmission unit transmits the information indicating the predetermined authentication method, a reservation instruction for reserving a connection to the first network, and a password for connecting to the first network, and
the computer is caused to further function as
a third transmission unit configured to, in a case where the communication apparatus has discovered the first network as a result of the first transmission unit transmitting the first search instruction to the communication apparatus, transmit, to the communication apparatus, a first connection instruction for causing the communication apparatus to execute connection processing for connecting to the first network.

4. The medium according to claim 1, wherein
the computer is caused to further function as
a first acquisition unit configured to, after the first search instruction is transmitted to the communication apparatus, acquire information indicating whether the first network has been discovered from the communication apparatus, and
a third transmission unit configured to, in a case where the information acquired by the first acquisition unit is information indicating that the first network has been discovered, transmit, to the communication apparatus, a first connection instruction for causing the communication apparatus to execute connection processing for connecting to the first network.

5. The medium according to claim 4, wherein
the first connection instruction includes a password for connecting to the first network.

6. The medium according to claim 1, wherein
the computer is caused to further function as
a second acquisition unit configured to, in a case where the connection setting instruction is accepted, acquire capability information of the communication apparatus, and
based on the capability information acquired by the second acquisition unit, it is controlled whether to transmit the first search instruction.

7. The medium according to claim 6, wherein
the capability information includes information indicating an authentication method supported by the communication apparatus.

8. The medium according to claim 1, wherein
the computer is caused to further function as
a third acquisition unit configured to, based on that the communication apparatus does not support the predetermined authentication method, acquire a list of external access points searched by the information processing apparatus,
a fourth transmission unit configured to, based on that the list acquired by the third acquisition unit includes an access point that forms a second network having the same SSID as the first network, transmit information indicating an authentication method used in the second network to the communication apparatus,
a second reception unit configured to, after the information indicating the authentication method used in the second network is transmitted, receive information indicating whether the authentication method is supported from the communication apparatus, and
a fifth transmission unit configured to, based on that the information received by the second reception unit is information indicating that the communication apparatus supports the authentication method used in the second network, transmit, to the communication apparatus, a second search instruction for causing the communication apparatus to execute search processing of searching for the second network.

9. The medium according to claim 1, wherein
the computer is caused to further function as
a third acquisition unit configured to, based on that the first network is not discovered by the communication apparatus as a result of the first transmission unit transmitting the first search instruction to the communication apparatus, acquire a list of external access points discovered by the information processing apparatus,
a fourth transmission unit configured to, based on that the list acquired by the third acquisition unit includes an access point that forms a second network having the same SSID as the first network, transmit information indicating an authentication method used in the second network to the communication apparatus,
a second reception unit configured to, after the information indicating the authentication method used in the second network is transmitted, receive information indicating whether the authentication method is supported from the communication apparatus, and
a fifth transmission unit configured to, based on that the information received by the second reception unit is information indicating that the communication apparatus supports the authentication method used in the second network, transmit, to the communication apparatus, a second search instruction for causing the communication apparatus to execute search processing of searching for the second network.

10. The medium according to claim 1, wherein
the computer is caused to further function as
a sixth transmission unit configured to, based on that the communication apparatus does not support an authentication method used in the first network, transmit a third search instruction for causing the communication apparatus to execute search processing of searching for an external access point of the communication apparatus to the communication apparatus,
a third reception unit configured to, after the third search instruction is transmitted to the communication apparatus by the sixth transmission unit, receive a result of the search processing from the communication apparatus,
a second reception unit configured to, based on that the result of the search processing received by the third reception unit does not include the predetermined access point, accept a user selection of an access point to be connected to the communication apparatus from the result of the search processing, and
a seventh transmission unit configured to transmit, to the communication apparatus, a second connection instruction for causing the communication apparatus to execute connection processing for connecting to a network formed by the access point that the second reception unit has accepted as the user selection.

11. The medium according to claim 1, wherein
the computer is caused to further function as
a first establishment unit configured to establish a connection between the information processing apparatus and the communication apparatus operating in a predetermined mode for performing the connection setting, and
the first transmission unit transmits the first search instruction via the connection between the information processing apparatus and the communication apparatus operating the predetermined mode, which is established by the first establishment unit.

12. The medium according to claim 11, wherein
the first establishment unit disconnects a connection between the information processing apparatus and the predetermined access point, and establishes a connection between the information processing apparatus and the communication apparatus operating in the predetermined mode.

13. The medium according to claim 12, wherein
the computer is caused to further function as
a third transmission unit configured to, based on that the communication apparatus has discovered the first network as a result of the first transmission unit transmitting the first search instruction to the communication apparatus, transmit, to the communication apparatus, a first connection instruction for causing the communication apparatus to execute connection processing for connecting to the first network, and
a second establishment unit configured to, after the first connection instruction is transmitted to the communication apparatus, establish a connection between the information processing apparatus and the predetermined access point.

14. The medium according to claim 11, wherein
the first establishment unit establishes a connection between the information processing apparatus and the communication apparatus operating in the predetermined mode using a second communication method different from a first communication method based on Wi-Fi without disconnecting a connection between the information processing apparatus and the predetermined access point using the first communication method.

15. The medium according to claim 1, wherein
in a case where the authentication method used in the first network is an authentication method complying with Wi-Fi Protected Access3 (WPA3), the communication apparatus does not support the authentication method used in the first network, and
in a case where the authentication method used in the first network is an authentication method complying with one of WPA and WPA2, the communication apparatus supports the authentication method used in the first network.

16. An information processing apparatus, comprising at least one memory and at least one processor which function as:
a first acceptance unit configured to accept a connection setting instruction for performing connection setting of a communication apparatus; and
a first transmission unit configured to transmit, to the communication apparatus, a first search instruction for causing the communication apparatus to execute search processing of searching for a first network formed by a predetermined access point connected to the information processing apparatus at least at a timing of accepting the connection setting instruction,
wherein, based on that the communication apparatus does not support a predetermined authentication method used in the first network, it is controlled not to transmit the first search instruction to the communication apparatus, and based on that the communication apparatus supports the predetermined authentication method, it is controlled to transmit the first search instruction to the communication apparatus.

17. A control method of an information processing apparatus, comprising:
accepting a connection setting instruction for performing connection setting of a communication apparatus; and
transmitting, to the communication apparatus, a first search instruction for causing the communication apparatus to execute search processing of searching for a first network formed by a predetermined access point connected to the information processing apparatus at least at a timing of accepting the connection setting instruction,
wherein, based on that the communication apparatus does not support a predetermined authentication method used in the first network, it is controlled not to transmit the first search instruction to the communication apparatus, and based on that the communication apparatus supports the predetermined authentication method, it is controlled to transmit the first search instruction to the communication apparatus.
